(19) United States
(12) Patent Application Publication
(10) Pub. No.: US 2025/0165976 A1
(43) Pub. Date: May 22, 2025

(54) MOBILE SETTLEMENT SYSTEM, MOBILE TERMINAL, AND METHOD FOR MOBILE SETTLEMENT SYSTEM

(71) Applicant: Toshiba Tec Kabushiki Kaisha, Tokyo (JP)

(72) Inventors: Kanako NAKAHARA, Shinagawa Tokyo (JP); Hikaru KOMIYAMA, Yokohama Kanagawa (JP)

(21) Appl. No.: 18/908,166

(22) Filed: Oct. 7, 2024

(30) Foreign Application Priority Data
Nov. 16, 2023 (JP) 2023-195425

(51) Int. Cl. G06Q 20/40; G06Q 20/32

(52) U.S. Cl. CPC G06Q 20/40145; G06Q 20/322

(57) ABSTRACT

According to one embodiment, a mobile terminal for a mobile settlement system for retail stores has a wireless communication unit and a storage unit storing a settlement application and additional settlement information required for at least one payment method. The terminal also has a biometric information acquisition unit for acquiring biometric information, a display screen, and a processor. The processor executes the settlement application and causes the display screen to display a payment method selection screen and receives a payment method selection. Biometric information is then acquired via the biometric information acquisition unit if the selected payment method requires the additional settlement information. The processor then acquires an authentication result for the acquired biometric information and outputs the additional settlement information stored in the storage unit to a settlement server if the authentication result indicates a successful biometric authentication.

### CROSS-REFERENCE TO RELATED APPLICATION

This application is based upon and claims the benefit of priority from Japanese Patent Application No. 2023-195425, filed Nov. 16, 2023, the entire contents of which are incorporated herein by reference.

### FIELD

Embodiments described herein relate generally to a mobile settlement system, a mobile terminal used for the system, and a method for a mobile settlement system.

### BACKGROUND

In recent years, a so-called mobile settlement service enables payment using a mobile terminal, such as a smartphone or a tablet, has been widely adopted for paying for purchases of goods and the like. In general, a user of the mobile terminal can use the mobile settlement service by installing a dedicated settlement application (software) required for using the mobile settlement service on the mobile terminal.

Once the settlement application is started on the mobile terminal, a list of cashless media for settlement purposes is displayed on a screen of the mobile terminal. The cashless media can be, for example, a credit card or an electronic money type. In this context, electronic money may be transportation-based electronic money operated by a transportation company (e.g., a transit service related pre-paid credit or voucher), distribution-based electronic money issued by a distribution-based company, code-based electronic money that enables payment by presenting or reading a code such as a barcode or a two-dimensional code, and the like. The user selects a cashless medium to be used for the settlement from the list. For example, if a credit card is selected, the user inputs information such as a card number and a security code for the credit card via the screen of the mobile terminal. After the credit card is authenticated using the input, the user can pay the price using the credit card.

If the mobile settlement service is introduced into a retail store, such as a supermarket, and the user of the mobile terminal can perform mobile settlement anywhere in the store, it may be difficult to identify whether a person exiting the store has already settled a purchase (made payment to properly complete a sales transaction) or not. Thus, in the retail store, a mobile settlement checkout area may be installed separately from the sales floor of the store. However, this system requires the user to perform the mobile settlement process only the designated checkout area.

As described above, when a credit card is to be selected as the cashless medium, the user may be required to input settlement information such as the card number or the security code on the screen of the mobile terminal. In such cases, most users will have to perform activities such as taking the credit card out from a wallet, j inputting the required information for the settlement via the mobile terminal, and then putting the credit card back in the wallet, all while being in the designated checkout area, and thus the user will end up staying (dwelling) longer in the checkout area. Consequently, the checkout area may become crowded during a busy time. This issue can be addressed by reducing the time necessary for a user to use a mobile settlement service.

### BRIEF DESCRIPTION OF THE DRAWINGS

FIG. 1 is a schematic diagram illustrating a schematic configuration of a mobile settlement system.

FIG. 2 is a block diagram of a support server.

FIG. 3 is a schematic diagram illustrating member data in a member master.

FIG. 4 is a schematic diagram illustrating a transaction file.

FIG. 5 is a block diagram of a mobile terminal.

FIG. 6 is a schematic diagram of a settlement table.

FIG. 7 is a schematic diagram depicting functional aspects of a processor in a settlement pre-registration mode and a shopping mode.

FIG. 8 is a flowchart of processing of a mobile terminal when a settlement pre-registration mode is selected.

FIG. 9 is a sequence diagram indicating signals exchanged between a mobile terminal and a support server a settlement pre-registration mode.

FIG. 10 is a diagram illustrating screens and screen transitions of a touch panel of a mobile terminal.

FIG. 11 and FIG. 12 are flowcharts of processing of a mobile terminal when a shopping mode is selected.

FIG. 13 is a flowchart of face authentication settlement processing.

FIG. 14 is a flowchart of fingerprint authentication settlement processing.

FIG. 15 is a sequence diagram indicating signals exchanged among a mobile terminal, a support server, and a settlement server in information processing in FIGS. 11 to 14.

FIG. 16 is a diagram illustrating screens and screen transitions of a touch panel of a mobile terminal.

FIG. 17 is a diagram illustrating screens and screen transitions of a touch panel of a mobile terminal.

FIG. 18 is a block diagram of a cart terminal.

FIG. 19 is a perspective view illustrating an example of a shopping cart provided with a cart terminal.

FIG. 20 is a flowchart of processing executed by a processor of a cart terminal.

FIG. 21 is a sequence diagram indicating signals exchanged among a cart terminal, a support server, and a mobile terminal in the information processing illustrated in FIG. 20.

FIG. 22 is a diagram illustrating screens and screen transitions for a cart terminal.

FIG. 23 is a diagram illustrating screens and screen transitions for a cart terminal.

### DETAILED DESCRIPTION

An exemplary embodiment provides improvements in the functioning of a mobile settlement system that can reduce the time required for a user to use a mobile settlement service. Embodiments relate to a technological solution to existing problems in mobile settlement service related to the speed and ease of use of such services in a retail environment.

In general, according to one embodiment, a mobile terminal for a mobile settlement system for retail stores comprises a wireless communication unit for connecting to external servers, a storage unit storing a settlement application and additional settlement information required for at least one payment method, a biometric information acquisition unit for acquiring biometric information of a user of the mobile terminal, a display screen for displaying information to the user, and a processor. The processor is configured to execute the settlement application, wherein, by executing the settlement application, the processor is configured to: cause the display screen to display a payment method selection screen, receive a user selection of a payment method via the payment method selection screen, acquire biometric information of the user via the biometric information acquisition unit when the selected payment method requires the additional settlement information to complete settlement, acquire an authentication result for the acquired biometric information, and output the additional settlement information stored in the storage unit to a settlement server if the authentication result indicates a successful authentication of the user based on the biometric information.

In general, according to one embodiment, a mobile settlement system includes request means, biometric information acquisition means, authentication means, and output means. The request means requests a target person of a transaction as to whether or not to execute biometric authentication settlement for the transaction through a mobile terminal carried by the target person. The biometric information acquisition means acquires, if an instruction to execute the biometric authentication settlement is received in response to the request, biometric information of the target person through the mobile terminal. The authentication means authenticates the target person using the biometric information acquired by the biometric information acquisition means. The output means outputs, if the target person is authenticated by the authentication means, information about a settlement required item registered in advance to a settlement server.

Hereinafter, certain example embodiments of a mobile settlement system that can reduce the time required for a user to use a mobile settlement service will be described using the drawings.

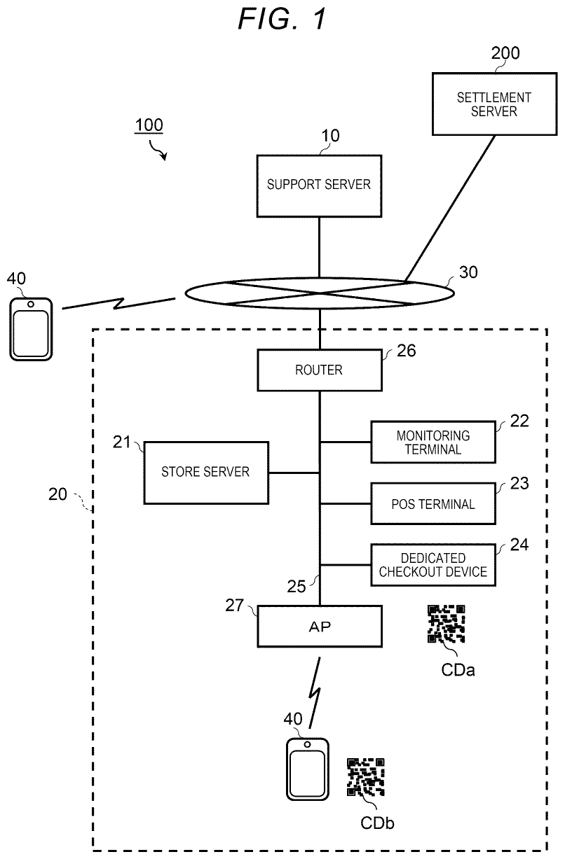

In the present embodiment, a mobile settlement system in a retail store such as a supermarket will be illustrated. In the retail store, a checkout area for users who want to use a mobile settlement service is provided separately from the sales area (sales floor) in which products for sale are displayed. In the checkout area, the user can pay a price of a commodity to be purchased in a cashless manner by operating a mobile terminal 40 (refer to FIG. 1). Mobile terminal 40 may be a smartphone, a tablet computer, or the like of the user.

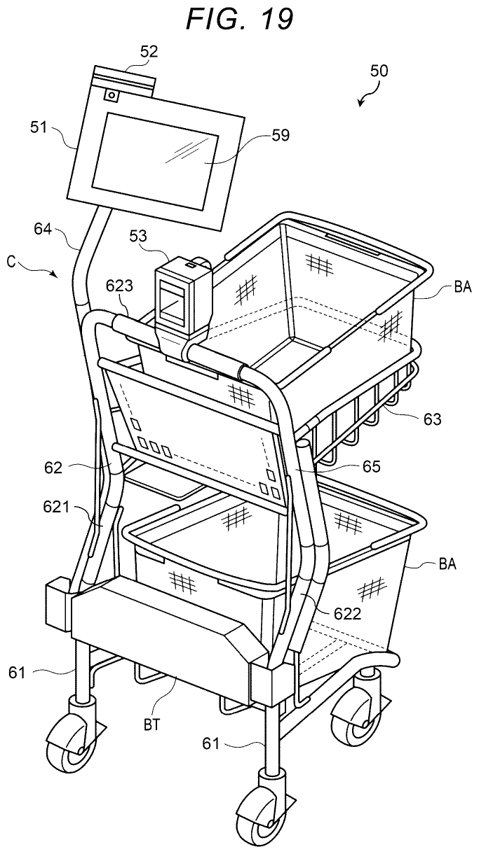

First, a mobile settlement system in a retail store with a self-commodity registration system that requires the user of the mobile terminal 40 to register items to be purchased by operating the mobile terminal 40 will be described. Next, a mobile settlement system in a retail store with a self-commodity registration system that requires the user to use a shopping cart-based terminal (cart terminal 50) to register items to be purchased (refer to FIGS. 18 and 19) will be described. In this explanation, the user is a customer involved in a sales transaction at the store. The user/customer may be referred to as a target person of a transaction. The user may also be referred to as a customer, a purchaser, a consumer, or the like. The sales transaction can be any commercial transaction that involves the sales of goods, services, or the like.

### First Embodiment

### Description of Configuration of Mobile Settlement System

FIG. 1 is a schematic diagram illustrating a schematic configuration of a mobile settlement system 100 according to the first embodiment. The mobile settlement system 100 includes a support server 10, a self-commodity registration system 20, and a network 30.

The support server 10 is a server for supporting the mobile settlement service. The support server 10 is also a server that supports a self-commodity registration service provided by the self-commodity registration system 20. The support server 10 may provide the service in an on-premises environment or provide the service in a cloud computing environment.

The self-commodity registration system 20 is constructed in a retail store such as a supermarket. The self-commodity registration system 20 includes a store server 21, a monitoring terminal 22, a point of sales (POS) terminal 23, a dedicated checkout device 24, and the like that are connected to an in-store network 25. In addition, in the self-commodity registration system 20, a router 26 is connected to the in-store network 25, and the self-commodity registration system 20 is connected to the network 30 through the router 26. Furthermore, in the self-commodity registration system 20, an access point 27 is connected to the in-store network 25, and the self-commodity registration system 20 can perform data communication with the mobile terminal 40 using a wireless LAN through the access point 27. The mobile terminal 40 can also communicate with each device of the self-commodity registration system 20 through the network 30 such as a mobile telephone communication network.

The store server 21 manages (tracks) sales information, commodity inventory information, order information, and the like of the store based on information about transactions settled in the store in which the self-commodity registration system 20 is constructed.

The monitoring terminal 22 is for monitoring customers performing a self-registration operation using the mobile terminal 40. The monitoring terminal 22 activities of a customer in the store, data related to a commodity being purchased by the customer, and the like are displayed on a monitor of the monitoring terminal.

The POS terminal 23 is a checkout device that processes settlement of a transaction for a customer who is not performing a self-registration operation. A store clerk is generally an operator of the POS terminal 23. The POS terminal 23 may be a distributed POS terminal system that is divided into a registration device and a checkout device. The registration device may be operated by the store clerk, and the checkout device may be operated by the customer. In some examples, POS terminal 23 may also be a fully self-checkout type POS terminal operated by the customer alone.

The dedicated checkout device 24 is a checkout device that is available to process settlement of a transaction with a customer who performs the self-registration operation. The customer can be the operator of the dedicated checkout device 24. For example, the dedicated checkout device 24 has a function of scanning a checkout barcode displayed on the mobile terminal 40 of a customer, a function of processing a payment corresponding to one of the various possible payment methods such as electronic money, a credit card, and cash, a function of recharging the electronic money account, and the like.

The dedicated checkout device 24 may be installed in the checkout area dedicated to the customers who perform the self-registration operation. The checkout area is also a checkout area for the users of the mobile settlement service. For example, a checkout permission code CDa (based on a two-dimensional code) is displayed at an entrance of this checkout area. The self-registration customer using the mobile terminal 40 is permitted to enter the checkout area by reading the checkout permission code CDa with the mobile terminal 40. The customer can then settle the transaction by operating the dedicated checkout device 24. If the customer is a user of the mobile settlement service, the customer can settle the transaction by operating the mobile terminal 40 in the checkout area using a cashless medium such as a credit card or electronic money.

The network 30 is a wide area network that uses a public line or a dedicated line as a relay network and that uses a wired local area network (LAN), a wireless LAN, a cellular communication network, a mobile telephone communication network, or the like as an access network. In addition to the router 26 of the self-commodity registration system 20, server systems such as the support server 10 and a settlement server 200 are connected to the network 30. In addition, the mobile terminal 40 can also be connected to the network 30 using wireless communication. The network 30 enables bidirectional data communication using, for example, an Internet protocol.

The mobile terminal 40 is a portable wireless communication terminal that can perform data communication with the support server 10 and the like using wireless communication using, for example, a mobile telephone communication network. The mobile terminal 40 is owned by the user of the mobile settlement service. The mobile terminal 40 also functions as a self-registration terminal in the retail store in which the self-commodity registration system 20 is constructed. For example, the mobile terminal 40 may be a smartphone or a tablet owned by the store customer.

For example, a store entrance code CDb (based on a two-dimensional code) is displayed at an entrance of the retail store. The store entrance code CDb is encoded setting information related to the store. The setting information may include a store code, in-store LAN information, mobile communication data, and the like. The in-store LAN information includes an SSID, a password, security information, and the like required for the mobile terminal 40 to connect to the access point 27 using the wireless LAN. The mobile communication data includes a timeout time, the number of retries, and the like required for the mobile terminal 40 to communicate with other devices of the self-commodity registration system 20. The mobile terminal 40 is enabled to perform wireless communication with each device of the self-commodity registration system 20 through the access point 27 by reading the store entrance code CDb.

The user who enters the store after reading the store entrance code CDb can input data required for registering products to be purchased by operating the mobile terminal 40 in the sales area. In addition, the user who enters the checkout area after reading the checkout permission code CDa can pay using a cashless medium by operating the mobile terminal 40.

The settlement server 200 provides an agent service for performing processing related to cashless settlement. Here, cashless settlement is a settlement method using a cashless medium such as a credit card or electronic money. In this context, electronic money includes transportation-based electronic money, distribution-based electronic money, code-based electronic money, and the like.

### Description of Configuration of Support Server

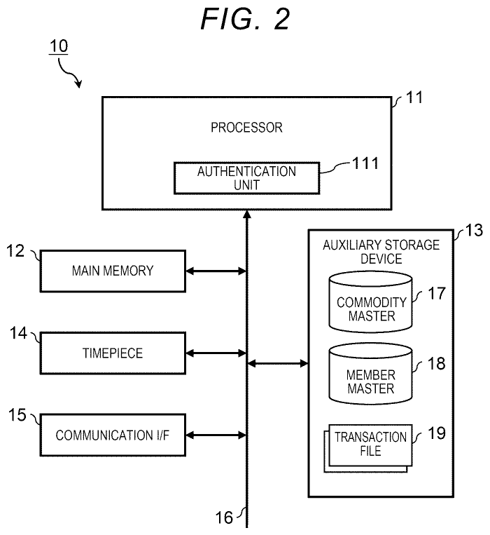

FIG. 2 is a block diagram illustrating a configuration of the support server 10. The support server 10 includes a processor 11, a main memory 12, an auxiliary storage device 13, a timepiece 14, a communication interface 15, and a system transmission path 16. The system transmission path 16 includes an address bus, a data bus, a control signal line, and the like. In the support server 10, the processor 11, the main memory 12, the auxiliary storage device 13, the timepiece 14, and the communication interface 15 are connected to the system transmission path 16. The support server 10 comprises the processor 11, the main memory 12, the auxiliary storage device 13, and the system transmission path 16 connecting the processor 11, the main memory 12, and the auxiliary storage device 13.

The processor 11 controls each component to implement the various functions of the support server 10 in accordance with an operating system or an application program. The processor 11 is, for example, a central processing unit (CPU). The processor 11 is preferably a multi-core processor that includes a plurality of processor cores and that can execute a plurality of types of processing in parallel.

The main memory 12 includes a non-volatile memory region and a volatile memory region. In the main memory 12, the operating system or the application program is stored in the non-volatile memory region. In the main memory 12, data required for the processor to execute processing for controlling each unit may be stored in the non-volatile or volatile memory region. In the main memory 12, the volatile memory region is used as a work area in which data is rewritten, as appropriate, by the processor. For example, the non-volatile memory region is a read only memory (ROM). The volatile memory region is a random access memory (RAM).

For example, an Electric Erasable Programmable Read-Only Memory (EEPROM), a hard disk drive (HDD), or a solid-state drive (SSD) can be used as the auxiliary storage device 13. Data used for performing various types of processing of the processor 11 and data created by processing of the processor 11 can be stored in the auxiliary storage device 13. The application program may be stored in the auxiliary storage device 13.

The timepiece 14 tracks a date and time. The processor 11 processes the date and time tracked by the timepiece 14 as a current date and time.

The communication interface 15 is for transmitting and receiving data between other devices connected through the network 30 in accordance with a communication protocol.

The support server 10 manages a database referred to as a commodity master 17 and a database referred to as a member master 18 in the auxiliary storage device 13. In addition, the support server 10 uses a part of a storage region of the auxiliary storage device 13 as a storage region for a transaction file 19.

The commodity master 17 is a database in which commodity data for each commodity sold in the retail store in which the self-commodity registration system 20 is constructed is accumulated. If there are a plurality of retail stores connected to the support server 10 through the network 30, the commodity master 17 can be prepared for each retail store separately.

In this context, the commodity data consists of items such as a commodity code, a commodity name, and a price. The commodity code is a unique code set for each commodity in order to identify each commodity. Each commodity can be provided with a barcode indicating the commodity code of the commodity. The user of the mobile terminal 40 can register the commodity to be purchased by reading the barcode with a reading portion (e.g., a camera 46 of the mobile terminal 40 in some examples).

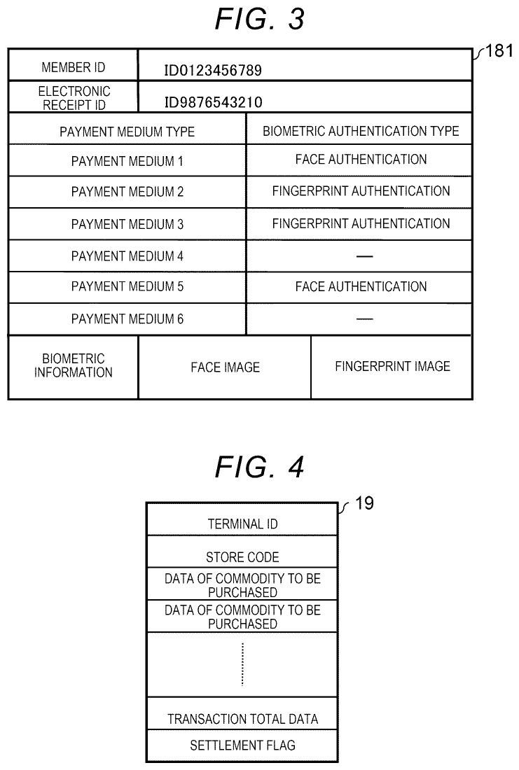

The member master 18 is a database in which member data 181 (refer to FIG. 3) for each user registered as a member of the mobile settlement service is accumulated.

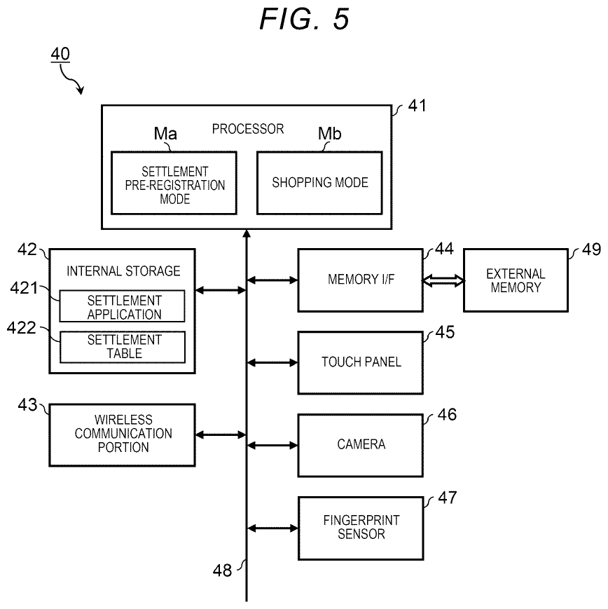

FIG. is a schematic diagram illustrating a 3 configuration of the member data 181. As illustrated, the member data 181 includes a member code, an electronic receipt ID, a biometric authentication type for each payment medium type, and biometric information. The member ID is unique identification information set for each user registered as a member. The user of the mobile terminal 40 can register as a member by installing a settlement application 421 (refer to FIG. 5) that is application software required for the mobile settlement service on the mobile terminal 40. The user is issued with a new member ID when registering as a member. The member data 181 of the user is registered in the member master 18, and the member ID is set in the mobile terminal 40. Accordingly, the user of the mobile terminal 40 can use the mobile settlement service in a commercial transaction at the retail store.

The electronic receipt ID is identification information required for receiving an electronic receipt, in which transaction detail data such as information about the commodities purchased in the commercial transaction, a total amount of money, and a transaction date and time is recorded. A user who uses the mobile settlement service generally cannot easily receive a paper receipt. Thus, the user may be required to register as a member of an electronic receipt service or otherwise agree to receive electronic receipts for transactions at the store. The user who registered as a member of the mobile settlement service further registers as an electronic receipt user. Registration as an electronic receipt user can also be performed using the mobile terminal 40. The user is then issued with a new electronic receipt ID after registering as an electronic receipt user. The electronic receipt ID is added to the member data 181 of the user. If the user registered as the member for using the mobile settlement service is already registered as an electronic receipt user, the electronic receipt ID may already be associated with the member ID.

The payment medium type is information for specifying a cashless medium with which payment can be made using the mobile settlement service. The cashless medium can be a credit card, a transportation-based electronic money, a distribution-based electronic money, a code-based electronic money, or the like. A unique payment medium type may be assigned for each type of cashless media.

The biometric authentication type is information for specifying the biometric information for performing identity verification. In the present example, biometric authentication is used as an identity verification method if the corresponding payment medium specified by the payment medium type is to be used. For example, if the identity verification is to be performed using face information (facial data), the biometric authentication type is referred to as “face authentication”. For example, if the identity verification is to be performed using fingerprint information (FP data), the biometric authentication type is referred to as “fingerprint authentication”.

The biometric information can be a biometric image registered in advance as data for the biometric authentication as specified by the biometric authentication type. For example, a face image of the user is registered (stored) in advance as the biometric information to be used for the biometric authentication type designated “face authentication”. For example, a fingerprint image of the user is registered in advance as the biometric information to be used for the biometric authentication type designated “fingerprint authentication”.

The transaction file 19 is a data file created for each customer who performs the self-registration operation in the retail store. When the customer who wants to perform the self-registration operation reads the store entrance code CDb with the reading portion of the mobile terminal 40, and the mobile terminal 40 is enabled to perform wireless communication with each device of the self-commodity registration system 20, the transaction file 19 of the customer is created in the support server 10.

FIG. 4 is a schematic diagram illustrating items stored in the transaction file 19. As illustrated, a terminal ID, the store code, a transaction number, the transaction date and time, data of the commodity to be purchased, transaction total data, a settlement flag, and the like are stored in the transaction file 19. The terminal ID is identification information for particularly specifying the mobile terminal 40 operated by the customer who performs the self-registration operation. A unique terminal ID is set for each mobile terminal 40. The support server 10 acquires the terminal ID from the mobile terminal 40 and writes the terminal ID in the transaction file 19.

The store code is identification information for particularly specifying the retail store. A unique store code is set for each retail store. The store code can be included in the store entrance code CDb. The support server 10 can thus acquire the store code from the mobile terminal 40 after the store entrance code CDb is read and then write the store code in the transaction file 19.

The data of the commodity to be purchased is data of product(s) self-registered by the user by operating the mobile terminal 40. This data includes the commodity code, the commodity name, the price, the number of items (quantity) to be purchased, an amount of money for purchase, and the like. Here, the price is a selling price per unit. The amount of money for purchase is an amount of money obtained by multiplying the unit price of the product by the quantity of the product to be purchased. Each time a commodity is self-registered by operating the mobile terminal 40, the support server 10 acquires the data of the commodity and writes the data in the transaction file 19.

The transaction total data is a total number of items being purchased and a total amount of money due for the products to be purchased in the transaction. Each time another product is added to the transaction, the support server 10 calculates and updates the transaction total in the transaction file 19.

The settlement flag is 1-bit data for identifying whether or not settlement of the transaction associated with the terminal ID is finished. In the present example, the settlement flag indicating that the settlement is not finished yet is “0”, and the settlement flag indicating that the settlement is already finished is “1”. The support server 10 sets the settlement flag to “O” until the settlement of the transaction is completed. Whether the transaction is settled using the dedicated checkout device 24 or using the mobile terminal 40, the support server 10 sets the settlement flag to “1” as appropriate.

The data written in the transaction file 19 are not limited to the above items. For example, items such as the transaction date and time, the transaction number, and an amount of money to be paid may be included.

FIG. 2 will be referred to again.

The processor 11 functions as an authentication unit 111. The authentication unit 111 is configured to perform the biometric authentication such as face authentication or fingerprint authentication. For example, the authentication unit 111 is configured to perform the identity verification as to whether or not the user is the identical person by comparing an acquired face image of the user with a face image of the user registered in advance. For example, the authentication unit 111 is configured to perform the identity verification as to whether or not the user is the identical person by comparing an acquired fingerprint image of the user with a fingerprint image of the user registered in advance.

### Description of Configuration of Mobile Terminal

FIG. 5 is a block diagram illustrating a configuration of the mobile terminal 40. The mobile terminal 40 includes a processor 41, an internal storage 42, a wireless communication portion 43, a memory interface 44, a touch panel 45, a camera 46, a fingerprint sensor 47, a system transmission path 48, and the like. The system transmission path 48 includes an address bus, a data bus, a control signal line, and the like. The system transmission path 48 connects the processor 41 to each of other units directly or through a signal input-output circuit and transmits data signals exchanged between each other.

In the mobile terminal 40, the processor 41 connect to the internal storage 42, and the wireless communication portion 43 through the system transmission path 48. In the mobile terminal 40, the memory interface 44, the touch panel 45, the camera 46, and the like are connected to the system transmission path 48 through a signal input-output circuit. The memory interface 44 is an interface for transmitting and receiving data signals with an external memory 49 that may be detachably mounted. The external memory 49 is typically an SD memory card, a mini SD card, a micro SD card, or the like. The touch panel 45 functions as a display device and an input device of the mobile terminal 40. The camera 46 functions as an imaging device of the mobile terminal 40. The mobile terminal 40 can read information about a barcode or a two-dimensional code from an image of the barcode or the two-dimensional code captured by the camera 46. That is, the camera 46 functions as the reading portion. The fingerprint sensor 47 detects a fingerprint of the user who operates the mobile terminal 40. Interfaces, devices, and the like connected to the system transmission path 48 are not limited to the above. Other interfaces, devices, and the like may be connected.

The processor 41 controls each component to implement the various functions of the mobile terminal 40 in accordance with an operating system or an application program. The processor 41 is, for example, a CPU.

The internal storage 42 is a storage device incorporated in a casing of the mobile terminal 40. The operating system or the application program is stored in the internal storage 42. Data required for executing processing via the processor 41 may be stored in the internal storage 42.

The wireless communication portion 43 performs wireless data communication using, for example, a short-range wireless communication network such as Wi-Fi or a mobile communication network.

In the mobile terminal 40, the settlement application 421 is installed in the internal storage 42. The settlement application 421 is application software required for the mobile settlement service. In addition, the settlement application 421 is application software for enabling the self-registration operation of the commodity to be purchased. An installation destination of the settlement application 421 is not limited to the internal storage 42. In the mobile terminal 40, the settlement application 421 may be installed in the external memory 49.

The mobile terminal 40 on which the settlement application 421 is installed sets a part of a storage region of the internal storage 42 as a region of a settlement table 422. In addition, the processor 41 operates in a settlement pre-registration mode Ma and a shopping mode Mb.

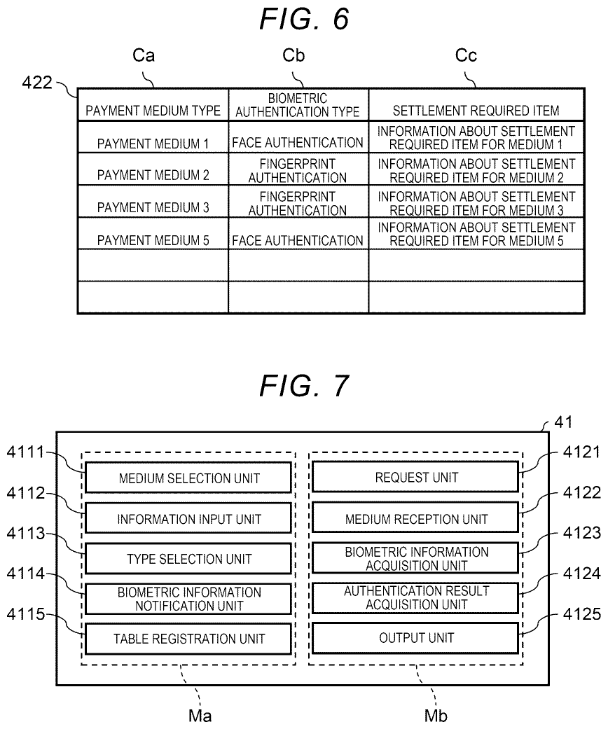

FIG. 6 is a schematic diagram illustrating a data structure of the settlement table 422. The settlement table 422 includes a column Ca as the payment medium type, a column Cb as the biometric authentication type, and a column Cc as a settlement required item.

The column Ca is a region for storing the payment medium type which is information for specifying the cashless medium with which payment can be made using the mobile settlement service. In the column Cb, the biometric authentication type for specifying the biometric authentication to be used for the identity verification of the payment medium specified by the payment medium type written in the identical row of the column Ca is written. In the column Cc, information about the settlement required item required for the payment medium specified by the payment medium type written in the identical row of the column Ca is written. For example, if the payment medium is a credit card, a credit card number and a security code are the information required for settlement. For example, if the payment medium is electronic money, a user ID and a password for logging in to a settlement server associated with an electronic money service are required information. The information required for settlement is not limited to the above examples. For example, an expiration date may be added as required information for a credit card.

FIG. 7 is a schematic diagram illustrating a functional configuration of the processor 41 required for operating in the settlement pre-registration mode Ma and the shopping mode Mb. The processor 41 functions as a medium selection unit 4111, an information input unit 4112, a type selection unit 4113, a biometric information notification unit 4114, and a table registration unit 4115 for operating in the settlement pre-registration mode Ma.

The medium selection unit 4111 is configured to permit selecting of the payment medium with which payment can be made using the mobile settlement service. The medium selection unit 4111 is configured to select the payment medium as designated by the user operating the mobile terminal 40 from the available payment media with which payment can be made using the mobile settlement service. The medium selection unit 4111 is configured to select from among a credit card, a transportation-based electronic money, a distribution-based electronic money, or a code-based electronic money.

The information input unit 4112 is configured to receive input of the information required for the payment medium. The information input unit 4112 is configured to receive input of the information required for settling the transaction with the payment medium selected by the medium selection unit 4111 through the mobile terminal 40. For example, if a credit card is selected, the information input unit 4112 is configured to receive input of the credit card number, the security code, and the like. For example, if electronic money is selected, the information input unit 4112 is configured to receive input of the user ID, the password, and the like for logging in to the settlement server for the electronic money.

The type selection unit 4113 is configured to permit selecting a type of biometric authentication to be used for the identity verification of the payment medium. The type selection unit 4113 is configured to select the biometric authentication type as designated by the user operating the mobile terminal 40 from among the types of the biometric authentication that can be used for the identity verification of the payment medium. For example, the type selection unit 4113 is configured to select between face authentication or fingerprint authentication.

The biometric information notification unit 4114 is configured to provide a notification of the biometric information required for the biometric authentication to the support server 10. The biometric information notification unit 4114 is configured to acquire the biometric information required for the biometric authentication of the selected the type and transmit the biometric information to the support server 10 through the network 30. For example, if face authentication is selected as the biometric authentication type, the biometric information notification unit 4114 is configured to transmit a face image of the user captured by the camera 46 to the support server 10. If fingerprint authentication is selected as the biometric authentication type, the biometric information notification unit 4114 is configured to transmit a fingerprint image as detected by the fingerprint sensor 47 to the support server 10.

The table registration unit 4115 is configured to register the payment medium type, the biometric authentication type, and the required settlement information items in the settlement table 422. The table registration unit 4115 is configured to register the type of the payment medium in the column Ca of the settlement table 422. The table registration unit 4115 is configured to register the biometric authentication type in the column Cb of the settlement table 422. The table registration unit 4115 is configured to register the information required for settlement required in the column Cc of the settlement table 422.

In addition, the processor 41 functions as a request unit 4121, a medium reception unit 4122, a biometric information acquisition unit 4123, an authentication result acquisition unit 4124, and an output unit 4125 for operating in the shopping mode Mb.

The request unit 4121 is configured to provide a function of asking whether or not to execute biometric authentication settlement for the transaction through the mobile terminal 40. The biometric authentication settlement is a settlement method using the biometric authentication as the identity verification method if the payment medium is used. In the present example, the biometric authentication is used as one of the identity verification methods of the payment media usable in the mobile settlement service. The request unit 4121 is configured to ask (inquire of) the user whether or not to use the biometric authentication as the identity verification method for a selected payment medium through the mobile terminal 40.

The medium reception unit 4122 is configured to provide a function of receiving the payment medium to be used for settling the transaction through the mobile terminal 40. The medium reception unit 4122 is configured to receive any payment medium from the payment media usable in the mobile settlement service.

The biometric information acquisition unit 4123 is configured acquire the biometric information through the mobile terminal 40 when an instruction to execute the biometric authentication settlement is received in response to the request made by the request unit 4121. For example, if an instruction to execute settlement with the payment medium for which the face authentication has been set as the biometric authentication type is received, the biometric information acquisition unit 4123 is configured to acquire a face image captured by the camera 46 of the mobile terminal 40, that is, the face image of the user of the mobile terminal 40, through the mobile terminal 40. For example, if an instruction to execute settlement with a payment medium for which fingerprint authentication has been set as the biometric authentication type is received, the biometric information acquisition unit 4123 is configured to acquire a fingerprint image as detected by the fingerprint sensor 47 of the mobile terminal 40, that is, the fingerprint image of the user of the mobile terminal 40, through the mobile terminal 40.

The authentication result acquisition unit 4124 is configured to acquire a result of the authentication attempt made using the biometric information provided by the biometric information acquisition unit 4123. The biometric authentication of the user of the mobile terminal 40 can be performed in the authentication unit 111 included in the support server 10. The authentication result acquisition unit 4124 is thus configured to acquire the authentication result from the authentication unit 111 of the support server 10.

The output unit 4125 is configured to output settlement required items (information) registered in advance to the settlement server 200 once a result indicating that the target person has been authenticated is acquired by the authentication result acquisition unit 4124. That is, the output unit 4125 is configured to output the required settlement information (settlement required items) written in the settlement table 422 for the payment medium received by the medium reception unit 4122 to the settlement server 200.

### Description of Operation in Settlement Pre-Registration Mode

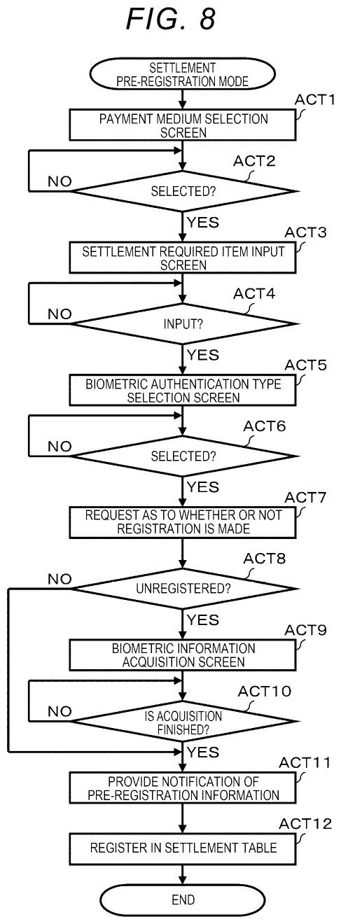

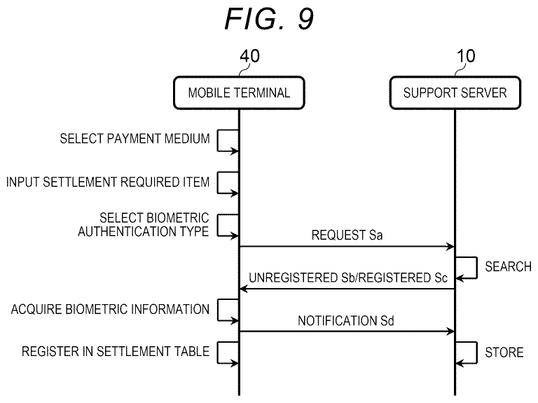

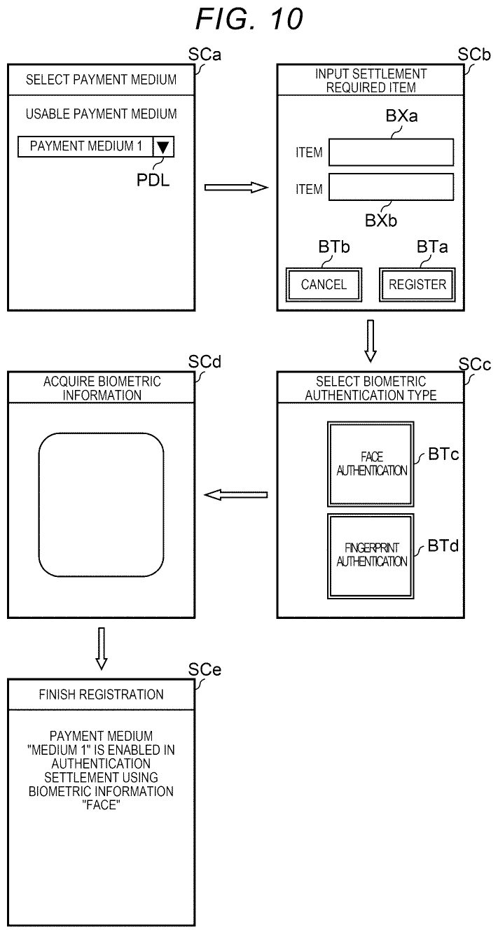

FIG. 8 is a flowchart illustrating a procedure of information processing executed by the processor 41 when the settlement pre-registration mode Ma is selected as an operation mode of the mobile terminal 40. FIG. 9 is a sequence diagram of signals exchanged between the mobile terminal 40 and the support server 10 in the information processing. FIG. 10 is a diagram illustrating a transition example of main screens displayed on the touch panel 45 of the mobile terminal 40. Operation of the mobile settlement system 100 when the settlement pre-registration mode Ma is selected will be described using FIGS. 8 to 10.

When the user of the mobile terminal 40 starts the settlement application 421, a top screen is displayed on the touch panel 45. The top screen is a screen on which whether to set the settlement pre-registration mode Ma or the shopping mode Mb as the operation mode of the mobile terminal 40 can be selected. Here, the user selects the settlement pre-registration mode Ma from the top screen. Then, the processor 41 starts the information processing of the procedure illustrated in the flowchart in FIG. 8.

First, in ACT 1, the processor 41 sets a screen of the touch panel 45 to a payment medium selection screen SCa (refer to FIG. 10). The payment medium selection screen SCa is a screen permitting the user to select a payment medium usable in the mobile settlement service. The user can select any payment medium from a pull-down list PDL of the payment medium selection screen SCa.

In ACT 2, the processor 41 of the mobile terminal 40 waits until a payment medium is selected. After any payment medium is selected by the user on the payment medium selection screen SCa, the processor 41 proceeds to ACT 3. Here, the processor 41 implements the function of the medium selection unit 4111 through the processing in ACT 1 and ACT 2.

In ACT 3, the processor 41 sets the screen of the touch panel 45 to a settlement required item input screen SCb (refer to FIG. 10). The settlement required item input screen SCb is a screen permitting the user to input the items (information) that is required for completing a settlement using the selected payment medium. For example, if a credit card is selected as the payment medium, the settlement required item input screen SCb is a screen for inputting the credit card number and the security code. For example, if electronic money is selected as the payment medium, the settlement required item input screen SCb is a screen for inputting the user ID and the password for logging in to the settlement server for the electronic money service. The user inputs the settlement required item corresponding to input boxes BXa and BXb of the settlement required item input screen SCb and touches a register button BTa. If the input information is to be canceled, the user touches a cancel button BTb. The register button BTa is for registering the information supplied in the input boxes BXa and BXb. The cancel button BTb is for providing an instruction to cancel the input.

In ACT 4, the processor 41 of the mobile terminal 40 waits until the information required for settlement (settlement required items) is input. Once the information input by the user on the settlement required item input screen SCb, the processor 41 proceeds to ACT 5. Here, the processor 41 implements the function of the information input unit 4112 through the processing in ACT 3 and ACT 4.

In ACT 5, the processor 41 sets the screen of the touch panel 45 to a biometric authentication type selection screen SCc (refer to FIG. 10). The biometric authentication type selection screen SCc is a screen permitting the user to select the type of biometric authentication to be used for the identity verification of the selected payment medium. In the present example, “face authentication” and “fingerprint authentication” are available as the biometric authentication types. A face authentication button BTc for selecting the biometric authentication type “face authentication” and a fingerprint authentication button BTd for selecting the biometric authentication type “fingerprint authentication” are displayed on the biometric authentication type selection screen SCc. If “face authentication” is to be selected as the biometric authentication type, the user touches the face authentication button BTc. If “fingerprint authentication” is to be selected as the biometric authentication type, the user touches the fingerprint authentication button BTd.

In ACT 6, the processor 41 of the mobile terminal 40 waits until a biometric authentication type is selected. Once any biometric authentication type is selected by the user on the biometric authentication type selection screen SCc, the processor 41 proceeds to ACT 7. Here, the processor 41 implements the function of the type selection unit 4113 through the processing in ACT 5 and ACT 6.

In ACT 7, the processor 41 sends a request the support server 10 to determine whether or not the selected biometric authentication type has already been set to be used for the identity verification of another payment medium registered by the user. Specifically, the processor 41 controls the wireless communication portion 43 to transmit a request command Sa (refer to FIG. 9) for the payment medium type. This control causes the request command Sa for the payment medium type to be wirelessly transmitted from the wireless communication portion 43. The request command Sa is received by the support server 10 via the network 30. The request command Sa includes information about the biometric authentication type selected through the biometric authentication type selection screen SCc and the member ID set in the mobile terminal 40.

As illustrated in FIG. 9, the processor 11 of the support server 10 receives the request command Sa for the payment medium type and searches the member master 18. Whether or not the biometric authentication type included in the request command Sa is already registered in the member data 181 of the member code included in the request command Sa is checked. If the biometric authentication type is not registered, the processor 11 responds to the mobile terminal 40 that sent the request command Sa with an unregistered response command Sb. If the biometric authentication type is already registered, the processor 11 responds to the mobile terminal 40 with a registered response command Sc.

FIG. 8 will be referred to again.

In ACT 8, the processor 41 of the mobile terminal 40 waits for a response command from the support server 10. If the unregistered response command Sb is received from the support server 10, the processor 41 proceeds to ACT 9. The processor 41 sets the screen of the touch panel 45 to a biometric information acquisition screen SCd (refer to FIG. 10).

The biometric information acquisition screen SCd is a screen for acquiring the face or fingerprint image which is the biometric information. The user who selects “face authentication” as the biometric authentication type directs his or her face toward the camera 46. At this point, the image captured by the camera 46 is displayed in a region ARa of the biometric information acquisition screen SCd. Thus, the user can perform adjustments such that the entire face will be shown in the region ARa. If a face image valid as biometric information for “face authentication” is captured by the camera 46, the processor 41 determines that acquisition of the biometric information is completed.

The user who selects “fingerprint authentication” as the biometric authentication type causes the fingerprint sensor 47 to read a fingerprint of the user. At this point, the fingerprint image as read by the fingerprint sensor 47 is displayed in the region ARa of the biometric information acquisition screen SCd. Thus, the user can perform adjustments such that the entire fingerprint will be shown in the region ARa. If a fingerprint image valid as biometric information for “fingerprint authentication” is read by the fingerprint sensor 47, the processor 41 determines that acquisition of the biometric information is completed.

In ACT 10, the processor 41 waits until acquisition of the biometric information is completed. If a determination that acquisition of the biometric information is completed is made, the processor 41 proceeds to ACT 11.

If the registered response command Sc is received from the support server 10 in ACT 8, the processor 41 skips the processing in ACT 9 and ACT 10. The processor 41 proceeds to ACT 11.

In ACT 11, the processor 41 executes notification processing of pre-registration information. This processing is processing for notifying the support server 10 of the payment medium type selected in the processing in ACT 1 and ACT 2 and the biometric authentication type selected in the processing in ACT 5 and ACT 6. In addition, if biometric information is acquired in the processing in ACT 9 and ACT 10, the support server 10 is also sent the biometric information. The support server 10 is not notified at this time about the information input in the processing in ACT 3 and ACT 4.

Specifically, the processor 41 controls the wireless communication portion 43 to transmit a notification command Sd (refer to FIG. 9) of the pre-registration information. This control causes the notification command Sd of the pre-registration information to be wirelessly transmitted from the wireless communication portion 43. The notification command Sd is received by the support server 10 via the network 30. The notification command Sd includes the payment medium type, the biometric authentication type, and the member ID set in the mobile terminal 40. In addition, the biometric information may be included. Here, the processor 41 implements the function of the biometric information unit through the notification 4114 processing in ACT 9 to ACT 11.

As illustrated in FIG. 9, the processor 11 of the support server 10 receives the notification command Sd of the pre-registration information and stores the pre-registration information in the member master 18. That is, the processor 11 writes the biometric authentication type included in the notification command Sd in the member data 181 for the member code included in the request command Sa as the biometric authentication type of the payment medium type included in the notification command Sd. In addition, if the biometric information is included in the notification command Sd, the processor 11 writes the biometric information in the member data 181 at this time.

The processor 41 of the mobile terminal 40 that sent the notification command Sd of the pre-registration information proceeds to ACT 12. In ACT 12, the processor 41 executes registration processing in the settlement table 422. This processing is processing of writing (storing) the biometric authentication type selected in the processing in ACT 5 and ACT 6 in the column Cb of the identical row to the column Ca in which the payment medium type selected in the processing in ACT 1 and ACT 2 is written. In addition, this processing is processing for writing the information input in the processing of ACT 3 and ACT 4 in the column Cc of the identical row to the column Ca in which the payment medium type selected in the processing in ACT 1 and ACT 2 is written. Here, the processor 41 implements the function of the table registration unit 4115 through the processing in ACT 12.

In the above manner, the processor 41 finishes the information processing if the settlement pre-registration mode Ma is selected.

By selecting the settlement pre-registration mode Ma, the user of the mobile terminal 40 can register the information required for settlement (settlement required item(s)), the biometric authentication type to be used for the identity verification, and the biometric information required for the biometric authentication type for each payment medium desired to be used in the mobile settlement system 100. The information for settlement required item(s) is stored in the settlement table 422 of the mobile terminal 40 for each payment medium. The biometric information is also transmitted to the support server 10 and stored for each user.

### Description of Operation in Shopping Mode

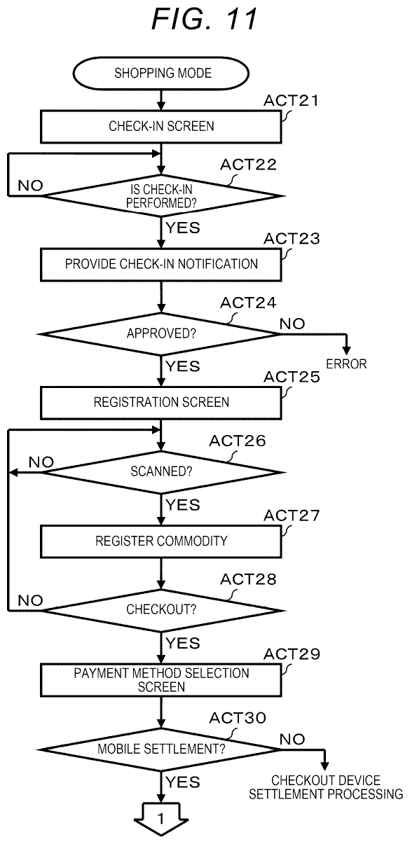

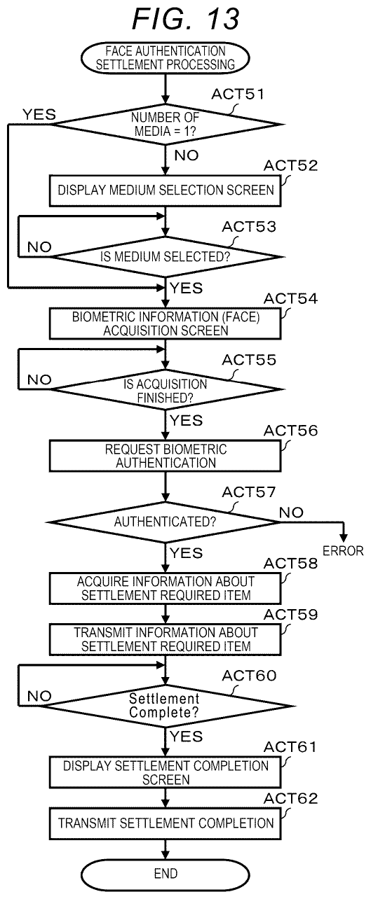

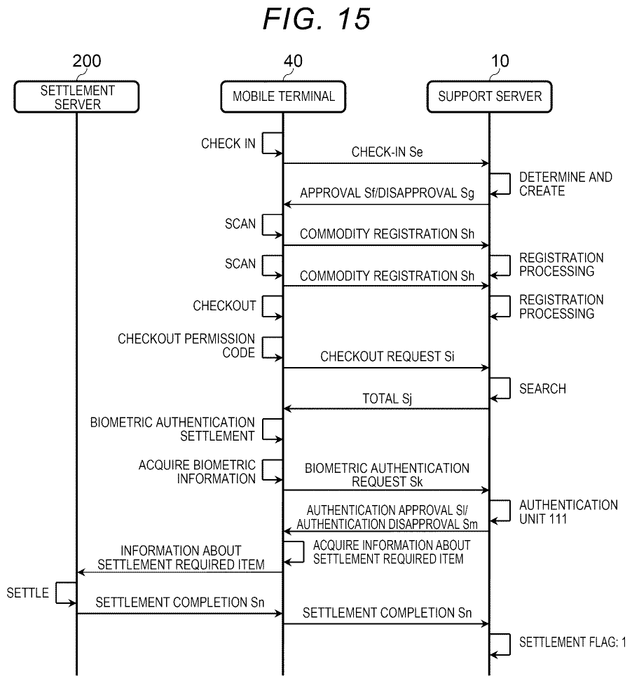

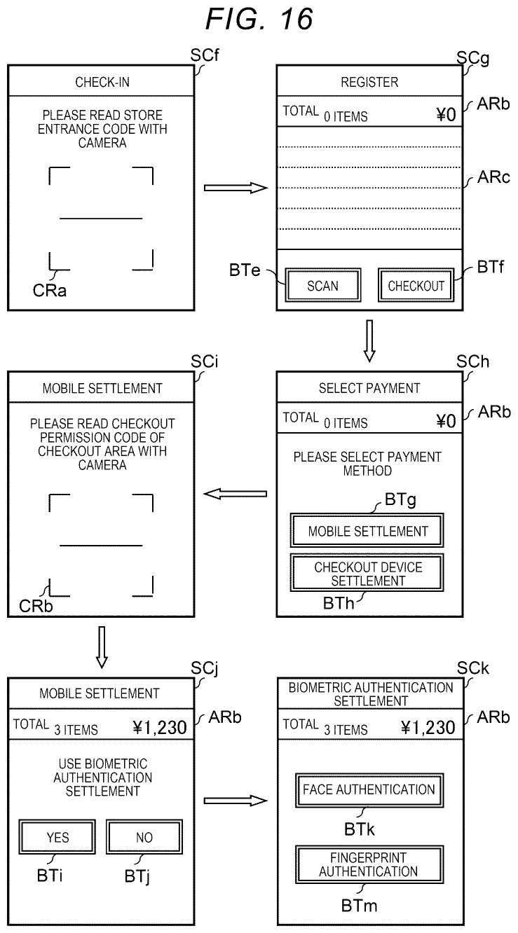

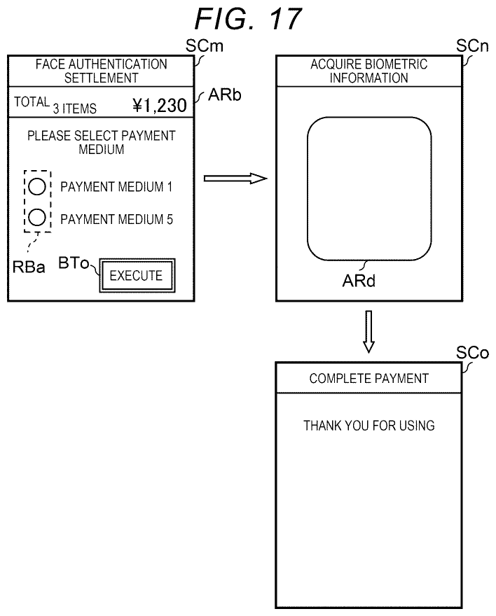

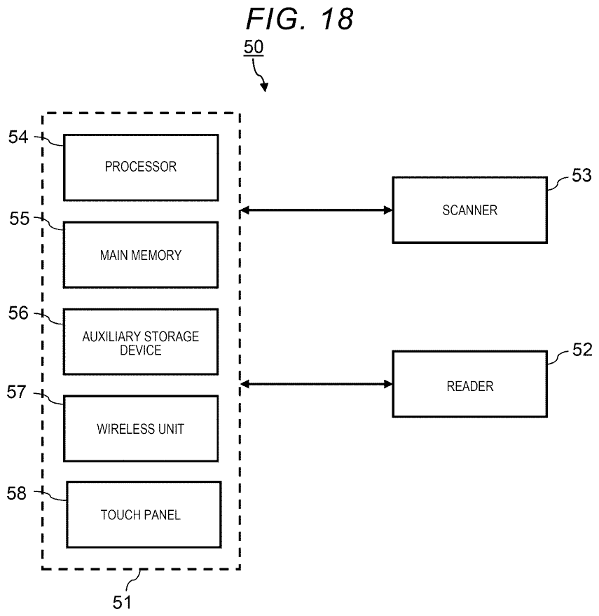

FIGS. 11 to 14 are flowcharts illustrating a procedure of information processing executed by the processor 41 if the shopping mode Mb is selected as the operation mode of the mobile terminal 40. FIG. 15 is a sequence diagram of signals exchanged among the mobile terminal 40, the support server 10, and the settlement server 200 in the information processing, and FIGS. 16 and 17 are diagrams illustrating a transition example of main screens displayed on the touch panel 45 of the mobile terminal 40. Hereinafter, a main operation of the mobile settlement system 100 if the shopping mode Mb is selected will be described using FIGS. 11 to 17.

If the user of the mobile terminal 40 starts the settlement application 421, the top screen is displayed on the touch panel 45. The user selects the shopping mode Mb from the top screen. Then, the processor 41 starts the information processing of the procedure illustrated in the flowchart in FIG. 11.

In ACT 21, the processor 41 sets the screen of the touch panel 45 to a check-in screen SCf (refer to FIG. 16). The check-in screen SCf is a screen on which guidance for scanning of the store entrance code CDb and a frame CRa indicating a code reading region are displayed. The user who enters the retail store holds the camera 46 of the mobile terminal 40 to the store entrance code CDb such that the store entrance code CDb displayed at the entrance of the store fits within the frame CRa of the check-in screen SCf. This operation of holding the camera 46 up to the store entrance code CDb will be referred to as a check-in operation.

In ACT 22, the processor 41 of the mobile terminal 40 waits until the check-in operation is performed. When the store entrance code CDb is read by the camera 46 by performing the check-in operation, the processor 41 proceeds to ACT 23. In ACT 23, the processor 41 controls the wireless communication portion 43 to provide a check-in notification to the support server 10. This control causes the wireless communication portion 43 to be connected to the access point 27 through the wireless LAN based on the in-store LAN data obtained from the store entrance code CDb. After being connected to the access point 27, the wireless communication portion 43 transmits a check-in command Se (refer to FIG. 15). The check-in command Se is received at the access point 27 and is transmitted to the support server 10 through the router 26. Alternatively, the check-in command Se is transmitted to the support server 10 through the network 30. The check-in command Se includes the terminal ID set in the mobile terminal 40.

As illustrated in FIG. 15, the processor 11 of the support server 10 receives the check-in command Se and then determines whether or not the check-in is valid. For example, if the transaction file 19 in which the terminal ID included in the check-in command Se is written and the settlement flag is “0” is stored in the auxiliary storage device 13, the settlement is determined to be not completed yet by the user of the mobile terminal 40 after the previous check-in operation. In this case, the processor 11 invalidates the check-in. If the check-in is invalid, the processor 11 transmits a disapproval response command Sg to the mobile terminal 40. If the check-in is valid, the processor 11 transmits an approval response command Sf to the mobile terminal 40. In addition, the processor 11 creates a new transaction file 19 in which the terminal ID included in the check-in command Se is written in the auxiliary storage device 13.

In ACT 24, the processor 41 of the mobile terminal 40 waits for the approval response command Sf. If the disapproval response command Sg is received from the support server 10, the processor 41 causes the check-in to end with error.

If the approval response command Sf is received from the support server 10, the processor 41 proceeds to ACT 25. In ACT 25, the processor 41 sets the screen of the touch panel 45 to a registration screen SCg (refer to FIG. 16). The registration screen SCg includes a region ARb in which the total number of items and the total amount of money are displayed and a region ARc in which detail data such as the commodity name and the price of the commodity to be purchased is displayed row by row. In addition, a scan button BTe and a checkout button BTf are displayed on the registration screen SCg. The scan button BTe is an operator for providing an instruction to scan the barcode provided in the commodity. The checkout button BTf is an operator for providing an instruction to check out the transaction.

The user of the mobile terminal 40 then starts shopping in the sales area (on the sales floor). If the user finds a commodity to be purchased, the user performs a registration operation such as reading the barcode of the commodity with the camera 46 by pressing the scan button BTe. Then, once the user finishes shopping, the user begins the transition to check out by pressing the checkout button BTf.

The processor 41 of the mobile terminal 40 displays the registration screen SCg then proceeds to ACT 26. In ACT 26, the processor 41 waits until the barcode of a commodity to be purchased is scanned. If the barcode of a commodity is read by the camera 46 after pressing of the scan button BTe, the processor 41 proceeds to ACT 27. In ACT 27, the processor 41 controls the wireless communication portion 43 to transmit a commodity registration command Sh (refer to FIG. 15) to the support server 10. This control causes the commodity registration command Sh to be wirelessly transmitted from the wireless communication portion 43. The commodity registration command Sh is received by the support server 10 via the network 30. The commodity registration command Sh includes the commodity code from the barcode along with the number of items (quantity) with the same commodity code to be purchased. In addition, the member ID set in the mobile terminal 40 may also be included.

The processor 11 of the support server 10 receives the commodity registration command Sh and executes commodity registration processing. That is, the processor 11 searches the commodity master 17 for the commodity code included in the commodity registration command Sh and acquires the associated commodity data such as the commodity name and the unit price. The processor 11 creates an entry for the commodity to be purchased including the commodity code, the commodity name, the unit price, the quantity to be purchased, the total amount for purchase, and the like and adds the entry to the transaction file 19 associated with the terminal ID included in the commodity registration command Sh.

Each time the barcode of a commodity is scanned, the processor 41 of the mobile terminal 40 repeats the processing of transmitting the commodity registration command Sh to the support server 10. In ACT 28, if the checkout button BTf is pressed, the processor 41 proceeds to ACT 29. In ACT 29, the processor 41 sets the screen of the touch panel 45 to a payment method selection screen SCh (refer to FIG. 16). The region ARb in which the total number of items in the transaction and the total amount of money due are displayed, a mobile settlement button BTg, and a checkout device settlement button BTh are also displayed on the payment method selection screen SCh. The mobile settlement button BTg is for providing an instruction to perform mobile settlement. The checkout device settlement button BTh is for providing an instruction to perform settlement using a dedicated checkout device 24. The user who wants to use mobile settlement touches the mobile settlement button BTg. The user who does not want to use mobile settlement selects the checkout device settlement button BTh.

In ACT 30, the processor 41 waits until the mobile settlement button BTg or the checkout device settlement button BTh is selected. Here, if the checkout device settlement button BTh is pressed, the processor 41 executes checkout device settlement processing using a dedicated checkout device 24. The checkout device settlement processing is well-known processing in the related art.

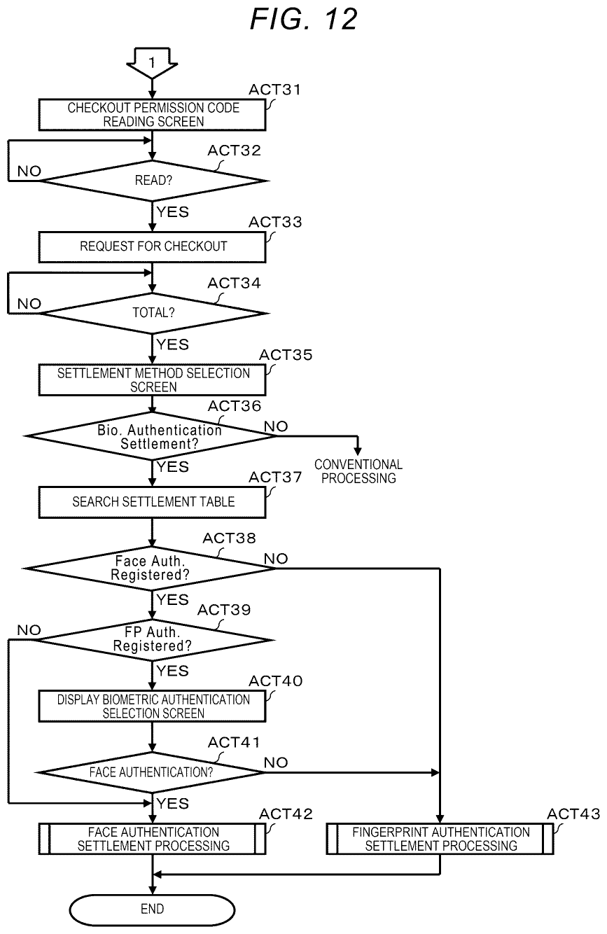

If the mobile settlement button BTg is selected, the processor 41 proceeds to ACT 31 in FIG. 12. In ACT 31, the processor 41 sets the screen of the touch panel 45 to a checkout permission code reading screen SCi (refer to FIG. 16). The checkout permission code reading screen SCi is a screen for reading the checkout permission code CDa at the entrance of the checkout area. The checkout permission code reading screen SCi is a screen on which guidance for scanning the checkout permission code CDa and a frame CRb indicating a code reading region are displayed. The user holds the camera 46 of the mobile terminal 40 up to the checkout permission code CDa such that the checkout permission code CDa displayed at the entrance of the checkout area fits within the frame CRb of the checkout permission code reading screen SCi.

In ACT 32, the processor 41 waits until the checkout permission code CDa is read. Once the checkout permission code CDa is read by the camera 46, the processor 41 proceeds to ACT In 33. ACT 33, the processor 41 controls the wireless communication portion 43 to transmit a checkout request command Si (refer to FIG. 15) to the support server 10. This control causes the wireless communication portion 43 to wirelessly transmit the checkout request command Si. The checkout request command Si is received at the access point 27 and is transmitted to the support server 10 through the router 26. Alternatively, the checkout request command Si is transmitted to the support server 10 through the network 30. The checkout request command Si includes the terminal ID already set in the mobile terminal 40.

As illustrated in FIG. 15, the processor 11 receives the checkout request command Si and searches the transaction file 19. The processor 11 acquires the transaction total data from the transaction file 19 matching the terminal ID included in the checkout request command Si. The processor 11 transmits a total response command Sj including the transaction total data to the mobile terminal 40 that sent the checkout request command Si.

In ACT 34, the processor 41 waits for the total response command Sj. Once the total response command Sj is received through the wireless communication portion 43, the processor 41 proceeds to ACT 35. In ACT 35, the processor 41 sets the screen of the touch panel 45 to a settlement method selection screen SCj (refer to FIG. 16). The settlement method selection screen SCj is a screen on which the user is requested to select whether or not to use biometric authentication settlement. The region ARb in which the total number of items and the total amount of money are displayed, a “yes” button BTi, and a “no” button BTj are displayed on the settlement method selection screen SCj. The “yes” button BTi is an operator for providing an instruction to use the biometric authentication settlement. The “no” button BTj is an operator for providing an instruction not to use the biometric authentication settlement. Both of the “yes” button BTi and the “no” button BTj are software keys. The total number of items and the total amount of money of the transaction total data included in the total response command Sj are displayed in the region ARb. The user who uses the biometric information registered in advance, that is, the user who want to use biometric authentication settlement, as the identity verification method of the payment medium to be used for the mobile settlement touches the “yes” button BTi. The user who does not want to use biometric information, that is, the user who does not use the biometric authentication settlement, touches the “no” button BTj. Here, the processor 41 implements the function of the request unit 4121 through the processing in ACT 35.

In ACT 36, the processor 41 of the mobile terminal 40 waits for as the user to select whether or not to use the biometric authentication settlement. If an input on the “no” button BTj is provided, the processor 41 transitions to conventional processing. The conventional processing includes processing in which the user manually inputs information required for mobile settlement using the desired payment medium/type into the mobile terminal 40. For example, if the payment medium is a credit card, the user inputs the credit card number and the security code by operating the mobile terminal 40. For example, if the payment medium is electronic money, the user inputs a user ID and password for logging in to the settlement server for the electronic money type by operating the mobile terminal 40. This processing is the same processing as described previously.

In ACT 36, if the “yes” button BTi is selected, the processor 41 proceeds to ACT 37. In ACT 37, the processor 41 searches the settlement table 422. In ACT 38, the processor 41 verifies whether or not the biometric authentication type “face authentication” is registered in the column Cb of the settlement table 422. If the biometric authentication type “face authentication” is registered in the column Cb, the processor 41 proceeds to ACT 39. In ACT 39, the processor 41 verifies whether or not the biometric authentication type “fingerprint authentication” is registered in the column Cb of the settlement table 422.

In ACT 39, if the biometric authentication type “fingerprint authentication” is registered in the column Cb, that is, if both of the biometric authentication types (“face authentication” and “fingerprint authentication”) are registered in the column Cb, the processor 41 proceeds to ACT 40. In ACT 40, the processor 41 sets the screen of the touch panel 45 to a biometric authentication selection screen SCk (refer to FIG. 16). The region ARb in which the total number of items and the total amount of money are displayed, a “face authentication” button BTk, and a “fingerprint authentication” button BTm are displayed on the biometric authentication selection screen SCk. The “face authentication” button BTk is an operator for providing an instruction to use the face authentication as the biometric authentication settlement. The “fingerprint authentication” button BTm is an operator for providing an instruction to use the fingerprint authentication as the biometric authentication settlement. The total number of items and the total amount of money of the transaction total data included in the total response command Sj are displayed in the region ARb. The user who wants to use face authentication as the identity verification method touches the “face authentication” button BTk. The user who wants to use fingerprint authentication touches the “fingerprint authentication” button BTm.

In ACT 41, the processor 41 of the mobile terminal 40 waits until the “face authentication” button BTk or “fingerprint authentication” button BTm is selected. If “face authentication” button BTk is selected, the processor 41 proceeds to ACT 42. In ACT 42, the processor 41 executes face authentication settlement processing. If the “fingerprint authentication” button BTm is selected, the processor 41 proceeds to ACT 43. In ACT 43, the processor 41 executes fingerprint authentication settlement processing.

In ACT 38, if the biometric authentication type “face authentication” is not registered in the column Cb of the settlement table 422, and only the biometric authentication type “fingerprint authentication” is registered in the column Cb, the processor 41 skips the processing in ACT 39 to ACT 41 and proceeds to ACT 43. That is, the processor 41 executes the fingerprint authentication settlement processing.

In ACT 39, if the biometric authentication type “fingerprint authentication” is not registered in the column Cb of the settlement table 422, but only the biometric authentication type “face authentication” is registered in the column Cb, the processor 41 skips the processing in ACT 40 and ACT 41 and proceeds to ACT 42. That is, the processor 41 executes the face authentication settlement processing.

### Description of Face Authentication Settlement Processing

FIG. a 13 is flowchart illustrating a specific procedure of the face authentication settlement processing. If the face authentication settlement processing is started, the processor 41 counts the number of biometric authentication types “face authentication” registered in the column Cb of the settlement table 422 in ACT 51. This number corresponds to the number of payment media for which “face authentication” is set as the biometric authentication type. If the number of biometric authentication types “face authentication”, that is, the number of payment media for which “face authentication” is set as the biometric authentication type, is greater than or equal to “2”, the processor 41 proceeds to ACT 52. In ACT 52, the processor 41 sets the screen of the touch panel 45 to a medium selection screen SCm (refer to FIG. 17). The region ARb in which the total number of items and the total amount of money are displayed and a plurality of payment media for which “face authentication” is set as the biometric authentication type are displayed on the medium selection screen SCm. A radio button RBa is displayed in association with each payment medium. In addition, an execute button BTo is displayed on the medium selection screen SCm. The user who verifies the medium selection screen SCm selects the radio button RBa of the payment medium for performing the settlement using the face authentication and touches the execute button BTo. Here, the processor 41 implements the function of the medium reception unit 4122 through the processing in ACT 52 and ACT 53.

The processor 41 of the mobile terminal 40 on which the medium selection screen SCm is displayed proceeds to ACT 53. In ACT 53, the processor 41 waits until a payment medium is selected. As described above, when any radio button RBa is selected and the execute button BTo is pressed, the processor 41 determines that the selected payment medium matches selected radio button RBa. The processor 41 proceeds to ACT 54. In ACT 54, the processor 41 sets the screen of the touch panel 45 to a biometric information acquisition screen SCn (refer to FIG. 17).

In ACT 51, if only one payment medium has the biometric authentication type “face authentication”, that is, the number of payment media for which “face authentication” has set as the biometric authentication type, is just “1”, the processor 41 skips the processing in ACT 52 and ACT 53. In ACT 54, the processor 41 sets the screen of the touch panel 45 to the biometric information acquisition screen SCn. The biometric information acquisition screen SCn is a screen for acquiring a face image as the biometric information to be used for authentication. In the face authentication settlement processing, the user directs his or her face towards the camera 46. At this point, the image captured by the camera 46 is displayed in a region ARd of the biometric information acquisition screen SCn. Thus, the user can perform adjustments such that the entire face is shown in the region ARd. After a valid face image is captured by the camera 46, the processor 41 determines that acquisition of the biometric information is completed.

In ACT 55, the processor 41 of the mobile terminal 40 waits until acquisition of the face image is completed. Once acquisition of the face image by the camera 46 is completed, the processor 41 proceeds to ACT 46. In ACT 46, the processor 41 controls the wireless communication portion 43 to transmit a biometric authentication request command Sk (refer to FIG. 15) to the support server 10. This control causes the wireless communication portion 43 to wirelessly transmit the biometric authentication request command Sk. The biometric authentication request command Sk is received at the access point 27 and is transmitted to the support server 10 through the router 26. Alternatively, the biometric authentication request command Sk is transmitted to the support server 10 through the network 30. The biometric authentication request command Sk includes data of the acquired face image and the member ID set in the mobile terminal 40. Here, the processor 41 implements the function of the biometric information acquisition unit 4123 through the processing in ACT 54 and ACT 55.

As illustrated in FIG. 15, the processor 11 receives the biometric authentication request command Sk and executes the operation as the authentication unit 111. That is, the processor 11 determines an authentication match level or the like by comparing the face image included in the biometric authentication request command Sk with the face image pre-registered in the member data 181 matching the member ID included in the biometric authentication request command Sk. If a determination is made that both face images match, the processor 11 transmits an authentication approval response command S1 to the mobile terminal 40 which sent the biometric authentication request command Sk. If a determination is made that the face images do not match, the processor 11 transmits an authentication disapproval response command Sm to the mobile terminal 40.

In ACT 57, the processor 41 of the mobile terminal 40 waits for a response command from the support server 10. If the authentication disapproval response command Sm is received through the wireless communication portion 43, the processor 41 causes the face authentication settlement processing to end with an error message or the like. If the face authentication settlement processing ends with an error, the user transitions to the conventional processing of manually inputting the information for settlement.

If the authentication approval response command S1 is received through the wireless communication portion 43, the processor 41 proceeds to ACT 58. In ACT 58, the processor 41 acquires the information required for settlement (settlement required items) from the settlement table 422. That is, the processor 41 acquires the information required for settlement stored in the column Cc of the row of the payment medium type selected in the processing in ACT 52 and ACT 53 or, alternatively, the only payment medium type for which the biometric authentication type “face authentication” has been set if there is only one. In ACT 59, the processor 41 transmits the required item(s) to the settlement server 200, as illustrated in FIG. 15. In ACT 60, the processor 41 waits for a settlement completion command Sn (refer to FIG. 15) from the settlement server 200. Here, the processor 41 implements the function of the authentication result acquisition unit 4124 through the processing in ACT 57. In addition, the processor 41 implements the function of the output unit 4125 through the processing in ACT 58 and ACT 59.

In ACT 60, the processor 41 waits for the settlement completion command Sn. If the settlement completion command Sn is received, the processor 41 proceeds to ACT 61. In ACT 61, the processor 41 sets the screen of the touch panel 45 to a settlement completion screen SCo (refer to FIG. 17). In addition, in ACT 62, the processor 41 controls the wireless communication portion 43 to transmit the settlement completion command Sn (refer to FIG. 15) to the support server 10. This control causes the settlement completion command Sn to be wirelessly transmitted from the wireless communication portion 43. The settlement completion command Sn is received by the support server 10 via the network 30. The settlement completion command Sn includes the terminal ID set in the mobile terminal 40.

As illustrated in FIG. 15, the support server 10 that receives the settlement completion command Sn updates the settlement flag of the transaction file 19 in which the terminal ID included in the settlement completion command Sn is set from “0” to “1”.

### Description of Fingerprint Authentication Settlement Processing

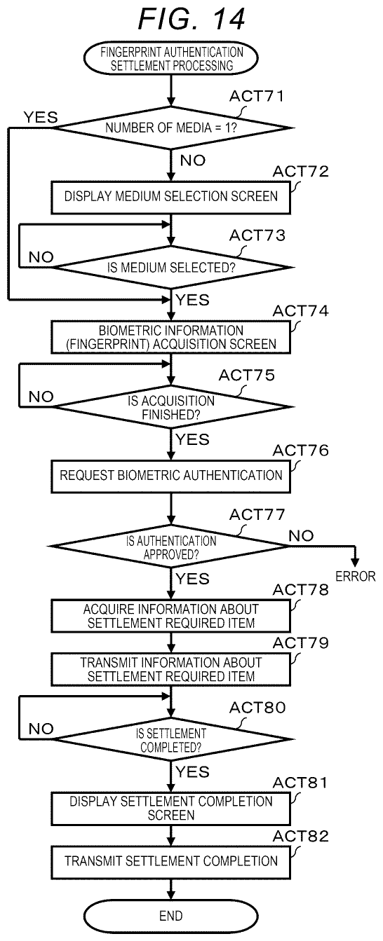

FIG. 14 is a flowchart illustrating a specific procedure of the fingerprint authentication settlement processing. If the fingerprint authentication settlement processing is started, the processor 41 counts the number of biometric authentication types “fingerprint authentication” registered in the column Cb of the settlement table 422 in ACT 71. This number corresponds to the number of payment media for which “fingerprint authentication” is set as the biometric authentication type. If the number of biometric authentication types “fingerprint authentication”, that is, the number of payment media for which “fingerprint authentication” set as is the biometric authentication type, is greater than or equal to “2”, the processor 41 proceeds to ACT 72. In ACT 72, the processor 41 sets the screen of the touch panel 45 to the medium selection screen SCm (refer to FIG. 17).

The processor 41 of the mobile terminal 40 on which the medium selection screen SCm is displayed proceeds to ACT 73. In ACT 73, the processor 41 waits until a payment medium is selected. Once a payment medium is selected, the processor 41 proceeds to ACT 74. In ACT 74, the processor 41 sets the screen of the touch panel 45 to the biometric information acquisition screen SCn (refer to FIG. 17). Here, the processor 41 implements the function of the medium reception unit 4122 through the processing in ACT 72 and ACT 73.

In ACT 71, if only one payment medium is set for “fingerprint authentication” (number of media=1), the processor 41 skips the processing in ACT 72 and ACT 73. In ACT 74, the processor 41 sets the screen of the touch panel 45 to the biometric information acquisition screen SCn. The biometric information acquisition screen SCn is a screen for acquiring a fingerprint image as biometric information. In the fingerprint authentication settlement processing, the user causes the fingerprint sensor 47 to read a fingerprint of the user. In this process, the fingerprint image read by the fingerprint sensor 47 is displayed in the region ARd of the biometric information acquisition screen SCn. Thus, the user can perform adjustments such that the entire fingerprint can be shown in the region ARd. If the fingerprint image valid, the processor 41 determines that acquisition of the biometric information is completed.

In ACT 75, the processor 41 of the mobile terminal 40 waits until acquisition of the fingerprint image which is the biometric information is completed. Once acquisition of the fingerprint image is completed by the fingerprint sensor 47, the processor 41 proceeds to ACT 76. In ACT 76, the processor 41 controls the wireless communication portion 43 to transmit the biometric authentication request command Sk (refer to FIG. 15) to the support server 10. This control causes the wireless communication portion 43 to wirelessly transmit the biometric authentication request command Sk. The biometric authentication request command Sk is received at the access point 27 and is transmitted to the support server 10 through the router 26. Alternatively, the biometric authentication request command Sk is transmitted to the support server 10 through the network 30. The biometric authentication request command Sk includes data of the acquired fingerprint image and the member ID set in the mobile terminal 40. Here, the processor 41 implements the function of the biometric information acquisition unit 4123 through the processing in ACT 74 and ACT 75.

As illustrated in FIG. 15, the processor 11 of the support server 10 receives the biometric authentication request command Sk and executes an operation as the authentication unit 111. That is, the processor 11 determines an authentication match level by comparing the fingerprint image included in the biometric authentication request command Sk with the fingerprint image pre-registered in the member data 181 for the member ID included in the biometric authentication request command Sk. If a determination is made that the fingerprint images match, the processor 11 transmits the authentication approval response command S1 to the mobile terminal 40 that sent the biometric authentication request command Sk. If a determination is made that fingerprint images do not match, the processor 11 transmits the authentication disapproval response command Sm to the mobile terminal 40.

In ACT 77, the processor 41 of the mobile terminal 40 waits for the response command from the support server 10 after transmitting the biometric authentication request command Sk. If the authentication disapproval response command Sm is received through the wireless communication portion 43, the processor 41 causes the fingerprint authentication settlement processing to end with an error message or the like. If the fingerprint authentication settlement processing ends as an error, the user transitions to conventional processing of manually inputting the information for the settlement required items.

If the authentication approval response command S1 is received through the wireless communication portion 43, the processor 41 proceeds to ACT 78. In ACT 78, the processor 41 acquires the settlement required items from the settlement table 422. That is, the processor 41 acquires the settlement required items stored in column Cc of the identical row for the payment medium type selected in the processing in ACT 72 and ACT 73 or, alternatively, the only payment medium type for which biometric authentication type “fingerprint authentication” has been set if there is only one. In ACT 79, the processor 41 transmits the settlement required item(s) to the settlement server 200, as illustrated in FIG. 15. In ACT 80, the processor 41 waits for the settlement completion command Sn (refer to FIG. 15) from the settlement server 200. Here, the processor 41 implements the function of the authentication result acquisition unit 4124 through the processing in ACT 77. In addition, the processor 41 implements the function of the output unit 4125 through the processing in ACT 78 and ACT 79.

In ACT 80, the processor 41 waits for the settlement completion command Sn. Once the settlement completion command Sn is received, the processor 41 proceeds to ACT 81. In ACT 81, the processor 41 sets the screen of the touch panel 45 to the settlement completion screen SCo (refer to FIG. 17). In addition, in ACT 82, the processor 41 controls the wireless communication portion 43 to transmit the settlement completion command Sn (refer to FIG. 15) to the support server 10. This control causes the settlement completion command Sn to be wirelessly transmitted from the wireless communication portion 43. The settlement completion command Sn is received by the support server 10 via the network 30. The settlement completion command Sn includes the terminal ID set in the mobile terminal 40.

As illustrated in FIG. 15, the support server 10 that receives the settlement completion command Sn updates the settlement flag of the transaction file 19 in which the terminal ID included in the settlement completion command Sn is set from “0” to “1”.

FIG. 12 will be referred to again. If the face authentication settlement processing or the fingerprint authentication settlement processing is finished, the processor 11 finishes the information processing if the shopping mode Mb is selected.

The user of the mobile terminal 40 can use the biometric authentication as the identity verification method in performing the mobile settlement of the transaction in the retail store. For example, the user who selects the credit card as the payment medium images the face of the user using the camera 46 of the mobile terminal 40. Alternatively, the user causes the fingerprint sensor 47 of the mobile terminal 40 to read the fingerprint of the user. The face image or the fingerprint image is transmitted to the support server 10, and the authentication unit 111 of the support server 10 performs the biometric authentication. Consequently, if the user is authenticated, settlement required item(s) of the credit card is transmitted to the settlement server 200 from the mobile terminal 40. Accordingly, the transaction of the user can be settled in the settlement server 200.

The user who uses biometric authentication is not required to manually input the settlement required items, such as the credit card number and the security code, into the mobile terminal 40. Thus, the user is not required to perform the activities of taking the credit card out from a wallet or the like, inputting the information required for settlement, and then putting the credit card back in the wallet or the like while in the checkout area. Consequently, since a user stays for a shorter time in the checkout area, congestion in the checkout area can be alleviated.

The user can set the type of biometric authentication for each of the payment medium types. The member data 181 illustrated in FIG. 3 and the settlement table 422 illustrated in FIG. 6 are examples of the user who sets the biometric authentication type “face authentication” for the payment medium type “payment medium 1” and the payment medium type “payment medium 5”, sets the biometric authentication type “fingerprint authentication” for the payment medium type “payment medium 2” and the payment medium type “payment medium 3”, and does not set the biometric authentication type for the payment medium type “payment medium 4” or the payment medium type “payment medium 6”.

When the mobile settlement is performed using “payment medium 1” or “payment medium 5”, the user performs identity verification using face authentication. When the mobile settlement is performed using “payment medium 2” or “payment medium 3”, the user performs identity verification using fingerprint authentication. When the mobile settlement is performed using “payment medium 4” or “payment medium 6”, the user performs identity verification using the conventional processing of manually inputting the information required for settlement (settlement required items). The user can generally change the identity verification method depending on the type of the payment medium.

Therefore, for example, a user who uses only the payment medium type “payment medium 1” and the payment medium type “payment medium 2” may set the biometric authentication type to “face authentication” for “payment medium 1” and the biometric authentication type to “fingerprint authentication” for “payment medium 2”. Then, when the user touches the face authentication button BTk on the biometric authentication selection screen SCk displayed on the touch panel 45 in the shopping mode Mb, the screen of the touch panel 45 transitions directly to the biometric information acquisition screen SCn. Similarly, if the user touches the fingerprint authentication button BTm, the screen of the touch panel 45 transitions directly to the biometric information acquisition screen SCn. That is, display of the medium selection screen SCm can be skipped, and the user can perform mobile settlement with a desired payment medium without specifically having to selecting the payment medium via a selection screen.

### Second Embodiment

### Description of Configuration of Mobile Settlement System

In the mobile settlement system of the second embodiment, the self-registration terminal in the retail store is a cart terminal 50 (refer to FIGS. 18 and 19). The rest of the aspects are the same as the first embodiment and thus, need not be further described, and FIG. 1 can be employed as generally representative of the second embodiment as well as the first embodiment.

### Description of Configuration of Cart Terminal

FIG. 18 is a block diagram illustrating a configuration of the cart terminal 50. In addition, FIG. 19 is a perspective view illustrating an example of a shopping cart (hereinafter, referred to as a cart C) provided with the cart terminal 50. As illustrated in FIG. 18, the cart terminal 50 includes a tablet 51, a reader 52, and a scanner 53. The tablet 51 is a mobile terminal configured with a processor 54, a main memory 55, an auxiliary storage device 56, a wireless unit 57, and a touch panel 58. The wireless unit 57 performs wireless communication with the access point 27.

The reader 52 is a device for reading data of a card medium. The scanner 53 is a device for reading a machine-readable code such as a barcode or a two-dimensional code. Each of the reader 52 and the scanner 53 is connected to the tablet 51 through a communication cable and is controlled by the processor 54 of the tablet 51.

As illustrated in FIG. 19, the cart C includes a caster portion 61 for movement, a handle frame portion 62, and a basket placement portion 63. The caster portion 61 includes four wheels for smoothly moving on a floor surface. In addition, the caster portion 61 includes a placement portion for placing a large item that does not fit in a basket BA. The handle frame portion 62 includes a pair of vertical frames 621 and 622 arranged on a rear wheel side of the caster portion 61 and a handle bar 623 that connects upper ends of the vertical frames 621 and 622. The basket placement portion 63 protrudes forward from a middle part of the handle frame portion 62. In the cart C, the basket BA provided in the store can be placed in the basket placement portion 63. Commodities are accommodated in the basket BA.

The scanner 53 of the cart terminal 50 is in a middle portion of the handle bar 623. The scanner 53 is attached to the handle bar 623 such that a reading window is positioned on a front side of the scanner 53. The front side is a side on which the customer who pushes the cart C by holding the handle bar 623 stands.

A pole 64 is attached to one vertical frame 621. A tip end of the pole 64 is positioned above the handle bar 623. The tablet 51 of the cart terminal 50 is attached to a tip end portion of the pole 64 with a screen of the touch panel 58 on the front side. The reader 52 is attached to the tablet 51 such that a card slit is positioned on the front side.

A battery BT is attached between the vertical frames 621 and 622 on a lower end side of the handle frame portion 62. The battery BT is a power supply for driving the tablet 51, the reader 52, and the scanner 53.

### Description of Operation in Second Embodiment

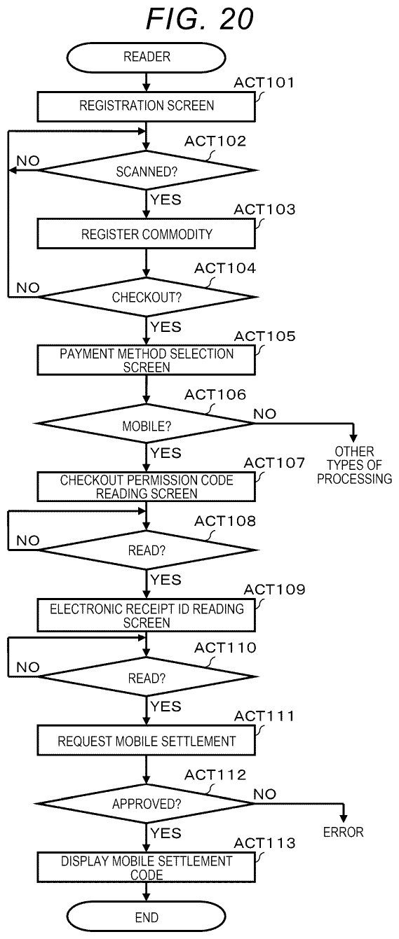

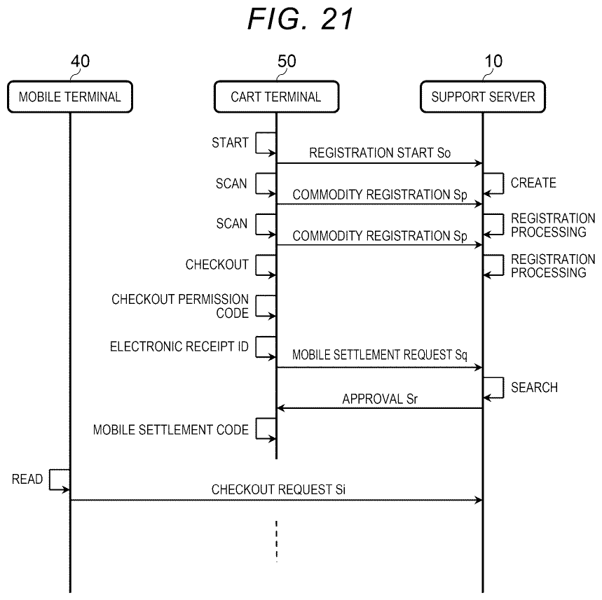

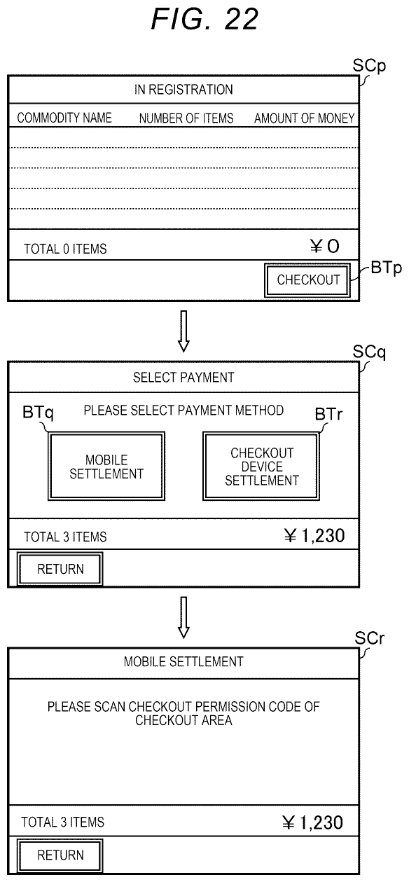

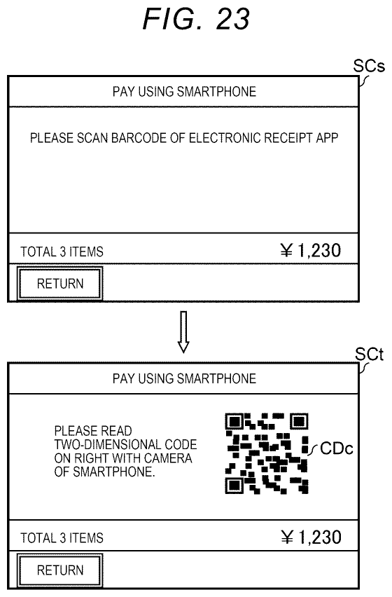

FIG. 20 is a flowchart illustrating a main procedure of information processing executed by the processor 54 of the tablet 51 in the cart terminal 50. FIG. 21 is a sequence diagram of signals exchanged among the cart terminal 50, the support server 10, and the mobile terminal 40 in the information processing, and FIGS. 22 and 23 are diagrams illustrating a transition example of main screens displayed on the tablet 51 of the cart terminal 50. Hereinafter, main operations of the cart terminal 50, the support server 10, and the mobile terminal 40 according to the second embodiment will be described using FIGS. 20 to 23. As in the first embodiment, the mobile terminal 40 is a smartphone or a tablet owned by the user who visits the retail store as the customer.

In the cart terminal 50, a start button is displayed on the tablet 51 as a default state. If the user who uses the cart C obtains the commodity to be purchased in the sales area, the user determines whether or not to input data required for registering the commodity to be purchased by operating the cart terminal 50. The user who determines to input the data required for registering the commodity to be purchased touches the start button.

By touching the start button, a registration start command So is transmitted to the support server 10 from the cart terminal 50, as illustrated in FIG. 21. The registration start command So includes a terminal ID of the cart terminal 50. The support server 10 that receives the registration start command So creates a new transaction file 19 in which the terminal ID included in the registration start command So is written in the auxiliary storage device 13.

After the start button is touched, the processor 54 of the tablet 51 starts the information processing of the procedure illustrated in the flowchart in FIG. 20. In ACT 101, the processor 54 sets the screen of the touch panel 58 to a registration screen SCp (refer to FIG. 22). The registration screen SCp includes a detail area in which the commodity name, the number of items to be purchased, the amount of money for purchase, and the like of the commodity to be purchased are displayed and a total area in which a total number of items to be purchased and a total amount of money for purchase are displayed. In addition, a checkout button BTp is displayed on the registration screen SCp. The checkout button BTp is an operator for providing an instruction to transition to payment of the price of the transaction.

The user then starts shopping in the sales area. If the user finds a commodity to be purchased, the user performs a registration operation for reading the barcode of the commodity with the scanner 53. The user then places the registered commodity in the basket BA of the cart C. Then, once the user finishes shopping in the sales area, the user transitions to check out by providing an input on the checkout button BTp.

FIG. 20 will be referred to again.

The processor 54 of the tablet 51 on which the registration screen SCp is displayed proceeds to ACT 102. In ACT 102, the processor 54 waits until the barcode of the commodity to be purchased is scanned. If the barcode of the commodity to be purchased is read by the scanner 53, the processor 54 proceeds to ACT 103. In ACT 103, the processor 54 registers the commodity. This processing is the same as the processing of the mobile terminal 40 described in ACT 27 (of FIG. 11) in the first embodiment. That is, a illustrated in FIG. 21, a commodity registration command Sp is transmitted to the support server 10 from the cart terminal 50. The support server 10 receives the commodity registration command Sp, creates the data of the commodity to be purchased, and adds the data of the commodity to be purchased to the transaction file 19 in which the terminal ID included in the commodity registration command Sp is set.

Each time the barcode of a commodity to be purchased is scanned, the processor 54 of the tablet repeats the processing in ACT 103. In ACT 104, if the input on the checkout button BTp is provided, the processor 54 proceeds to ACT 105. In ACT 105, the processor 54 sets the screen of the touch panel 58 to a payment method selection screen SCq (refer to FIG. 22). A region in which the total number of items and the total amount of money are displayed, a mobile settlement button BTq, and a checkout device settlement button BTr are displayed on the payment method selection screen SCq. The mobile settlement button BTq is an operator for providing an instruction to perform the mobile settlement. The checkout device settlement button BTr is for providing an instruction to perform the settlement using dedicated checkout device 24. The user who wants to use mobile settlement touches the mobile settlement button BTq. The user who does not want to use mobile settlement provides an input on the checkout device settlement button BTr.

In ACT 106, the processor 54 waits until the mobile settlement button BTq or the checkout device settlement button BTr is pressed. Here, if the checkout device settlement button BTr is selected, the processor 54 executes the checkout device settlement processing using the dedicated checkout device 24. The checkout device processing settlement is well-known processing in the related art.

If the mobile settlement button BTq is selected, the processor 54 proceeds to ACT 107. In ACT 107, the processor 54 sets the screen of the touch panel 58 to a checkout permission code reading screen SCr (refer to FIG. 22). The checkout permission code reading screen SCr is a screen on which guidance for reading the checkout permission code CDa prepared at the entrance of the checkout area is displayed. The user causes the scanner 53 to read the checkout permission code CDa at the entrance of the checkout area.

In ACT 108, the processor 54 of the tablet 51 waits until the checkout permission code CDa is read. Once the checkout permission code CDa is read by the scanner 53, the processor 54 proceeds to ACT 109. In ACT 109, the processor 54 sets the screen of the touch panel 58 to an electronic receipt ID reading screen SCs (refer to FIG. 23). The electronic receipt ID reading screen SCs is a screen on which guidance for reading an electronic receipt ID is displayed. The user operates the mobile terminal 40 to display a barcode associated with the electronic receipt ID on the screen. The user causes the scanner 53 to read the barcode.

In ACT 110, the processor 54 of the tablet 51 waits until the electronic receipt ID is read. Once the electronic receipt ID is read by the scanner 53, the processor 54 proceeds to ACT 111. In ACT 111, the processor 54 transmits a mobile settlement request command Sq (refer to FIG. 21) to the support server 10. The mobile settlement request command Sq includes the terminal ID of the cart terminal 50.

As illustrated in FIG. 21, the support server 10 receives the mobile settlement request command Sq and then searches for the transaction file 19. If the support server 10 finds the transaction file 19 matching the terminal ID included in the mobile settlement request command Sq, the support server 10 returns an approval command Sr to the cart terminal 50. The approval command Sr includes the terminal ID included in the mobile settlement request command Sq.

In ACT 112, the processor 54 of the tablet 51 waits for the approval command Sr. Once the approval command Sr is received from the support server 10, the processor 54 proceeds to ACT 113. In ACT 113, the processor 54 sets the screen of the touch panel 58 to a mobile settlement code screen SCt (refer to FIG. 23). A two-dimensional code CDc readable by the camera 46 of the mobile terminal 40 is displayed on the mobile settlement code screen SCt. The two-dimensional code CDc indicates the terminal ID included in the approval command Sr.

As illustrated in FIG. 21, the user who performs the mobile settlement using the mobile terminal 40 causes the camera 46 to read the two-dimensional code CDc shown on the mobile settlement code screen SCt. Once the two-dimensional code CDC is read, the processor 41 of the mobile terminal 40 acquires the terminal ID from the two-dimensional code CDc. The processor 41 transmits the checkout request command Si including the terminal ID to the support server 10.

Then, as in the first embodiment, the mobile terminal 40 and the support server 10 execute the operation after the mobile terminal 40 transmits the checkout request command Si to the support server 10.

Accordingly, even the user who uses the cart terminal 50 can use the mobile settlement service as in the first embodiment. Consequently, since user stays for a shorter in the checkout area, and congestion can be alleviated.

### Other Exemplary Embodiments

The support server 10 is illustrated as storing the biometric information of the user in the above exemplary embodiments. As another exemplary embodiment, the mobile terminal 40 stores the biometric information of the user. The processor 41 of the mobile terminal 40 may transmit a biometric authentication request command Sk including the biometric information acquired through the biometric information acquisition screen SCn and the biometric information stored in advance to the support server 10. Alternatively, the mobile terminal 40 may function as the authentication unit 111 and transmit information required for settlement to the settlement server 200 if authentication is successful. In some examples, store server 21 may function as the authentication unit 111.

The mobile terminal 40 is illustrated as storing the settlement required items (information required for settlement) in the above exemplary embodiments. In another exemplary embodiment, the support server 10 may store the settlement required items for each user. In this case, the support server 10 may transmit the information required for settlement to the settlement server 200 after the identity of the user is verified by biometric authentication using the authentication unit 111.

In addition, in some examples, a part or portion of the information required for settlement may be stored in the mobile terminal 40 and another part or portion of the required information may be stored in the support server 10. For example, a credit card number may be stored in the mobile terminal 40 and the security code may be stored in the member master 18 of the support server 10. In such a case, the mobile terminal 40 can transmit the biometric information acquired through the camera 46 or the fingerprint sensor 47 along with the credit card number to the support server 10. If the biometric information is authenticated, the support server 10 then transmits the received credit card number along with the security code stored in the member master 18 to the settlement server 200. In this configuration, since the credit card number and the security code are stored in different locations, the security code will not be revealed even if the mobile terminal 40 is stolen. Thus, unauthorized credit card settlement can be prevented.

While face authentication and fingerprint authentication are illustrated as the biometric authentication methods available in the above examples, biometric authentication using other types of biometric information is possible. For example, a vein pattern matching or an iris matching method may be employed. In addition, the type of the biometric authentication usable with the mobile settlement service may be limited to only one type rather than having multiple options.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosed inventions.

What is claimed is:

1. A mobile terminal for a mobile settlement system for retail stores, the mobile terminal comprising:
a wireless communication unit for connecting to external servers;
a storage unit storing a settlement application and additional settlement information required for at least one payment method;
a biometric information acquisition unit for acquiring biometric information of a user of the mobile terminal;
a display screen for displaying information to the user; and
a processor configured to execute the settlement application, wherein, by executing the settlement application, the processor is configured to:
cause the display screen to display a payment method selection screen,
receive a user selection of a payment method via the payment method selection screen,
acquire biometric information of the user via the biometric information acquisition unit when the selected payment method requires the additional settlement information to complete settlement,
acquire an authentication result for the acquired biometric information, and
output the additional settlement information stored in the storage unit to a settlement server if the authentication result indicates a successful authentication of the user based on the biometric information.

2. The mobile terminal according to claim 1, wherein the storage unit stores the additional settlement information for a plurality of payment methods.

3. The mobile terminal according to claim 1, wherein the biometric information acquisition unit is a camera.

4. The mobile terminal according to claim 1, wherein the biometric information acquisition unit is a fingerprint sensor.

5. The mobile terminal according to claim 1, wherein
the selected payment method is a credit card, and
the additional settlement information includes a security code.

6. The mobile terminal according to claim 1, wherein
the selected payment method is an electronic money service, and
the additional settlement information includes a user ID and a password.

7. The mobile terminal according to claim 1, wherein the biometric information is a facial image or a fingerprint.

8. The mobile terminal according to claim 1, wherein the authentication result is obtained from an external server.

9. A mobile settlement system for retail stores, the mobile settlement system comprising:
a support server;
an access point in a retail store to connect to a mobile terminal in the retail store;
a checkout area code sign at a position in the retail store near a checkout area in which mobile settlement via the mobile terminal is permitted, wherein
the mobile terminal includes:
a wireless communication unit for connecting to external servers;
a storage unit storing a settlement application and additional settlement information required for at least one payment method;
a biometric information acquisition unit for acquiring biometric information of a user of the mobile terminal;
a display screen for displaying information to the user; and
a processor configured to execute the settlement application, wherein, by executing the settlement application, the processor is configured to:
cause the display screen to display a payment method selection screen,
receive a user selection of a payment method via the payment method selection screen,
acquire biometric information of the user via the biometric information acquisition unit when the selected payment method requires the additional settlement information to complete settlement,
acquire an authentication result for the acquired biometric information from the support server, and
output the additional settlement information stored in the storage unit to a settlement server if the authentication result indicates a successful authentication of the user based on the biometric information.

10. The system according to claim 9, wherein the storage unit stores the additional settlement information for a plurality of payment methods.

11. The mobile settlement system according to claim 9, wherein the biometric information acquisition unit is a camera.

12. The mobile settlement system according to claim 9, wherein the biometric information acquisition unit is fingerprint sensor.

13. The mobile settlement system according to claim 9, wherein
the selected payment method is a credit card, and
the additional settlement information includes a security code.

14. The mobile settlement system according to claim 9, wherein
the selected payment method is an electronic money service, and
the additional settlement information includes a user ID and a password.

15. The mobile settlement system according to claim 9, wherein the biometric information is a facial image or a fingerprint.

16. A method for a mobile settlement system for retail stores, the method comprising:
storing additional settlement information required for at least one payment method in a storage unit;
causing a display screen of the mobile terminal to display a payment method selection screen;
receiving a user selection of a payment method via the payment method selection screen;
acquiring biometric information of a user of the mobile terminal via a biometric information acquisition unit of the mobile terminal when the selected payment method requires the additional settlement information to complete settlement;
acquiring an authentication result for the acquired biometric information; and
outputting the additional settlement information stored in the storage unit to a settlement server if the authentication result indicates a successful authentication of the user based on the biometric information.

17. The method according to claim 16, wherein the storage unit stores the additional settlement information for a plurality of payment methods.

18. The method according to claim 16, wherein the biometric information acquisition unit is a camera or fingerprint sensor of the mobile terminal.

19. The method according to claim 16, wherein
the selected payment method is a credit card, and
the additional settlement information includes a security code.

20. The method according to claim 16, wherein the authentication result is obtained from an external server.
